(19) United States
(12) Patent Application Publication
(10) Pub. No.: US 2012/0309306 A1
(43) Pub. Date: Dec. 6, 2012

(54) APPARATUS AND METHOD TO PERFORM COMMUNICATION IN WIRELESS POWER TRANSMISSION SYSTEM

(75) Inventors: Nam Yun Kim, Seoul (KR); Sang Wook Kwon, Seongnam-si (KR); Yun Kwon Park, Dongducheon-si (KR); Young Tack Hong, Seongnam-si (KR)

(73) Assignee: Samsung Electronics Co., Ltd., Suwon-si (KR)

(21) Appl. No.: 13/484,654

(22) Filed: May 31, 2012

Related U.S. Application Data
(60) Provisional application No. 61/491,953, filed on Jun. 1, 2011.

(30) Foreign Application Priority Data
Nov. 17, 2011 (KR) 10-2011-0120415

(51) Int. Cl. H04B 7/00; H04B 5/00

(52) U.S. Cl. 455/41.1; 455/66.1

(57) ABSTRACT

An apparatus and method to perform communication in a wireless power transmission system are provided. A source device of the wireless power transmission system, includes a communication unit configured to transmit an access standard instruction on a communication channel having a frequency that is not used for wireless power transmission. The source device further includes a controller configured to assign, to a target device, a control identifier (ID) if a response signal responding to the access standard instruction is received from the target device. The controller is further configured to determine an initial wireless power to be transmitted to the target device based on a change in a temperature of the source device, or a battery state of the target device, or a change in an amount of a power received by the target device, or a change in a temperature of the target device, or any combination thereof.

### CROSS-REFERENCE TO RELATED APPLICATION(S)

This application claims the benefit under 35 U.S.C. §119(e) of U.S. Provisional Application No. 61/491,953, filed on Jun. 1, 2011, in the United States Patent and Trademark Office, and claims the benefit under 35 U.S.C. §119(a) of Korean Patent Application No. 10-2011-0120415, filed on Nov. 17, 2011, in the Korean Intellectual Property Office, the entire disclosures of which are each incorporated herein by reference for all purposes.

### BACKGROUND

1. Field

The following description relates to an apparatus and method to perform communication in a wireless power transmission system.

2. Description of Related Art

Research on wireless power transmission has been started to overcome problems, such as an increasing inconvenience of wired power supply and limits to existing battery capacities, and due to an increase in various electronic devices including electric vehicles, mobile devices, and the like. One wireless power transmission system may use resonance characteristics of radio frequency (RF) elements. For example, such a wireless power transmission system may include a source device configured to supply power, and a target device configured to receive the supplied power. To efficiently transmit power from the source device to the target device, the source device and the target device may need to exchange information on a state of the source device and information on a state of the target device, with each other. In other words, there may be a need to perform communication between the source device and the target device.

### SUMMARY

In one general aspect, there is provided a source device of the wireless power transmission system, including a communication unit configured to transmit an access standard instruction on a communication channel having a frequency that is not used for wireless power transmission. The source device further includes a controller configured to assign, to a target device, a control identifier (ID) if a response signal responding to the access standard instruction is received from the target device. The controller is further configured to determine an initial wireless power to be transmitted to the target device based on a change in a temperature of the source device, or a battery state of the target device, or a change in an amount of a power received by the target device, or a change in a temperature of the target device, or any combination thereof.

The communication unit is further configured to transmit, to the target device, the control ID. The communication unit is further configured to receive, from the target device, a response signal indicating that the target device has received the control ID. The communication unit is further configured to transmit, to the target device, a target information request signal requesting information about the target device. The communication unit is further configured to receive, from the target device, a target information response signal including the information about the target device.

The source device further includes a source resonator, and a power transmitting unit configured to wirelessly transmit, to the target device, the initial wireless power through a magnetic coupling between the source resonator and a target resonator of the target device.

The source device further includes a power amplifier configured to receive a power supply voltage. The source device further includes a lookup table configured to store changes in the temperature of the target device and corresponding adjustments of the power supply voltage. The controller is further configured to detect the change in the temperature of the target device based on data from the target device. The controller is further configured to adjust the power supply voltage based on the change in the temperature of the target device and the lookup table

The controller is further configured to detect a change in an output power of the power amplifier, and determine that a load of the target device has changed based on the change in the output power of the power amplifier. The communication unit is further configured to transmit, to the target device, a charging information request signal requesting information regarding a power being transferred to the load of the target device, and receive, from the target device, a charging information response signal including the information regarding the power being transferred to the load of the target device.

The controller is further configured to select the communication channel from a plurality of communication channels having respective frequencies that are not used for wireless power transmission. The controller is further configured to transmit a channel occupancy signal indicating that the communication channel is being used, and a state information signal indicating an operating mode of the source device.

In another general aspect, there is provided a target device of a wireless power transmission system, including a communication unit configured to receive, from a source device, a channel occupancy signal and an access standard instruction, using a frequency of a communication channel. The communication unit is further configured to transmit, to the source device, a response signal responding to the access standard instruction. The target device further includes a controller configured to determine the communication channel as a channel used to communicate with the source device based on the channel occupancy signal. The controller is further configured to generate the response signal corresponding to the access standard instruction. The target device further includes a target resonator configured to receive, from the source device, an initial wireless power determined based on a change in a temperature of the source device, or a battery state of the target device, or a change in an amount of a power received by the target device, or a change in a temperature of the target device, or any combination thereof.

The communication unit is further configured to receive, from the source device, a state information signal indicating an operating mode of the source device.

When the state information signal indicates a communication between the source device and another target device in an access mode or a charging mode, the controller is further configured to wait for communication with another source device.

The communication unit is further configured to receive, from the source device, a control identifier (ID). The communication unit is further configured to transmit, to the source device, a response signal indicating that the target device has received the control ID. The communication unit is further configured to receive, from the source device, a target information request signal requesting information about the target device. The communication unit is further configured to transmit, to the source device, a target information response signal including the information about the target device.

When charging of a load of the target device is determined to be completed, the controller is further configured to open an electrical connection between the target device and the load to prevent a power from being transferred to the load.

When the controller is awaken, the controller is further configured to initialize hardware of the target device. The controller is further configured to acquire a serial number of the target device, a battery type of the target device, a power transmission parameter, and a parameter of the communication channel, from a system configuration block (SCB).

In yet another general aspect, there is provided a method of a wireless power transmission system, including transmitting an access standard instruction on a communication channel having a frequency that is not used for wireless power transmission. The method further includes assigning, to a target device, a control identifier (ID) if a response signal responding to the access standard instruction is received from the target device. The method further includes determining an initial wireless power to be transmitted to the target device based on a change in a temperature of a source device, or a battery state of the target device, or a change in an amount of a power received by the target device, or a change in a temperature of the target device, or any combination thereof.

The method further includes transmitting, to the target device, the control ID. The method further includes receiving, from the target device, a response signal indicating that the target device has received the control ID. The method further includes transmitting, to the target device, a target information request signal requesting information about the target device. The method further includes receiving, from the target device, a target information response signal including the information about the target device.

The method further includes wirelessly transmitting, to the target device, the initial wireless power through a magnetic coupling between a source resonator of the source device and a target resonator of the target device.

The method further includes detecting a change in output power of a power amplifier of the source device. The method further includes determining that a load of the target device has changed based on the output power of the power amplifier.

The method further includes selecting the communication channel from a plurality of communication channels having respective frequencies that are not used for wireless power transmission. The method further includes transmitting a channel occupancy signal indicating that the communication channel is being used, and a state information signal indicating an operating mode of the source device.

In still another general aspect, there is provided a method of a wireless power transmission system, including receiving, from a source device, a channel occupancy signal and an access standard instruction, using a frequency of a communication channel. The method further includes transmitting, to the source device, a response signal responding to the access standard instruction. The method further includes determining the communication channel as a channel used to communicate with the source device based on the channel occupancy signal. The method further includes generating the response signal responding to the access standard instruction. The method further includes receiving, from the source device, an initial wireless power determined based on a change in a temperature of the source device, or a battery state of a target device, or a change in an amount of a power received by the target device, or a change in a temperature of the target device, or any combination thereof.

The method further includes receiving, from the source device, a state information signal indicating an operating mode of the source device.

The response signal includes the battery state of the target device, or the change in the amount of the power received by the target device, or the change in the temperature of the target device, or any combination thereof.

Other features and aspects may be apparent from the following detailed description, the drawings, and the claims.

### BRIEF DESCRIPTION OF THE DRAWINGS

FIG. 1 is a diagram illustrating an example of a wireless power transmission system.

FIG. 2 is a block diagram illustrating an example of a communication apparatus in a wireless power transmission system.

FIG. 3 is a block diagram illustrating another example of a communication apparatus in a wireless power transmission system.

FIG. 4 is a diagram illustrating an example of a format of a frame transmitted by a communication apparatus in a wireless power transmission system.

FIG. 5 is a diagram illustrating an example of an access mode between a source and a single target in a wireless power transmission system.

FIG. 6 is a diagram illustrating an example in which a load of a target is changed in a charging mode in a wireless power transmission system.

FIG. 7 is a diagram illustrating an example of an operation of a source that is performed when a load of a target is changed in a charging mode in a wireless power transmission system.

FIG. 8 is a diagram illustrating an example in which a target is removed during charging in a wireless power transmission system.

FIG. 9 is a diagram illustrating an example of an operation of a source device that is performed when a target is removed during charging in a wireless power transmission system.

FIG. 10 is a diagram illustrating an example of an access mode between a source device and a plurality of targets in a wireless power transmission system.

FIG. 11 is a diagram illustrating an example in which a source device verifies a plurality of targets and sets a supplied power in a wireless power transmission system.

FIG. 12 is a diagram illustrating an example in which charging of one of a plurality of targets is completed in a wireless power transmission system.

FIG. 13 is a diagram illustrating an example of operations of a source device and a plurality of targets when charging of one of the targets is completed in a wireless power transmission system.

FIG. 14 is a diagram illustrating an example in which one of a plurality of targets is removed during charging of the targets in a wireless power transmission system.

FIG. 15 is a diagram illustrating an example of operations of a source device and a plurality of targets when one of the targets is removed during charging of the targets in a wireless power transmission system.

FIGS. 16A and 16B are diagrams illustrating examples of a distribution of a magnetic field in a feeder and a resonator.

FIGS. 17A and 17B are diagrams illustrating an example of a wireless power transmitter.

FIG. 18A is a diagram illustrating an example of a distribution of a magnetic field within a resonator based on feeding of a feeding unit.

FIG. 18B is a diagram illustrating examples of equivalent circuits of a feeding unit and a resonator.

FIG. 19 is a diagram illustrating an example of an electric vehicle charging system.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, description of well-known functions and constructions may be omitted for increased clarity and conciseness.

A scheme of performing communication between a source device and a target device may include an in-band communication scheme and an out-band communication scheme. The in-band communication scheme includes communication performed between the source device and the target device in a same frequency band as used for power transmission. The out-band communication scheme includes communication performed between the source device and the target device in a separate frequency band than that used for power transmission.

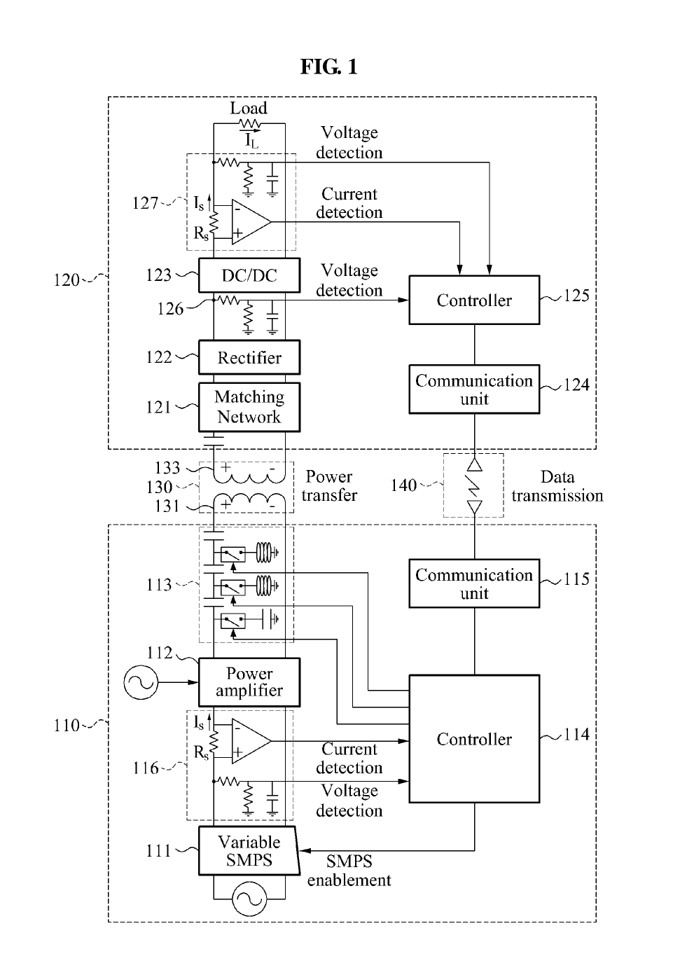

FIG. 1 illustrates an example of a wireless power transmission system. The wireless power transmission system includes a source device 110 and a target device 120. The source device 110 includes a device configured to supply wireless power, and may include all electronic devices enabling power supply, for example, a pad, a terminal, a television (TV), and the like. The target device 120 includes a device configured to receive supplied wireless power, and may include all electronic devices requiring power, for example, a terminal, a TV, a vehicle, a washing machine, a radio, an electric light, and the like. The source device 110 includes a variable switching mode power supply (SMPS) 111, a power amplifier 112, a matching network 113, a controller 114, and a communication unit 115.

The variable SMPS 111 generates direct current (DC) voltage by switching alternating current (AC) voltage in a band of tens of hertz (Hz) output from a power supply. The variable SMPS 111 may output DC voltage of a predetermined level, or may adjust an output level of DC voltage based on the control of the controller 114.

The variable SMPS 111 controls supplied voltage based on a level of power output from the power amplifier 112 so that the power amplifier 112 operates in a saturation region with high efficiency at all times, and enables a maximum efficiency to be maintained at all levels of the output power. The power amplifier 112 may have class-E features.

For example, when a common SMPS is used instead of the variable SMPS 111, a variable DC-to-DC (DC/DC) converter needs to be additionally used. In this example, the common SMPS and the variable DC/DC converter control supplied voltage based on the level of the power output from the power amplifier 112 so that the power amplifier 112 operates in the saturation region with high efficiency at all times, and enables the maximum efficiency to be maintained at all levels of the output power.

A power detector 116 detects an output current and an output voltage of the variable SMPS 111, and transfers, to the controller 114, information on the detected current and the detected voltage. Additionally, the power detector 116 may detect input current and input voltage of the power amplifier 112.

The power amplifier 112 generates power by converting DC voltage of a predetermined level to AC voltage, using a switching pulse signal in a band of a few megahertz (MHz) to tens of MHz. Accordingly, the power amplifier 112 converts the DC voltage supplied to the power amplifier 112 to AC voltage, using a reference resonant frequency F_{Ref}, and generatese communication power used for communication or charging power used to charge. The communication power and/or the charging power may be used in a plurality of target devices, e.g., the target device 120.

The communication power may include low power of 0.1 milliwatt (mW) to 1 mW. The charging power may include high power of 1 mW to 200 W that is consumed in a device load of a target device, e.g., the target device 120.

In various examples described herein, the term “charging” may refer to supplying power to a unit or element that is configured to charge power. Additionally, the term “charging” may refer to supplying power to a unit or element that is configured to consume power. The units or elements may include, for example, batteries, displays, sound output circuits, main processors, and/or various sensors.

Also, the term “reference resonant frequency” may refer to a resonant frequency that is used by the source device 110. Additionally, the term “tracking frequency” may refer to a resonant frequency that is adjusted by a preset scheme.

The controller 114 detects a reflected wave of the communication power or the charging power, and detects mismatching that may occur between a target resonator 133 and a source resonator 131 based on the detected reflected wave. To detect the mismatching, for example, the controller 114 may detect an envelope of the reflected wave, a power amount of the reflected wave, and/or the like.

The matching network 113 compensates for impedance mismatching between the source resonator 131 and the target resonator 133 to be optimal matching, under the control of the controller 114. The matching network 113 may be connected through a switch, based on a combination of a capacitor and an inductor, under the control of the controller 114.

The controller 114 computes a voltage standing wave ratio (VSWR) based on a voltage level of the reflected wave, and based on a level of an output voltage of the source resonator 131 or the power amplifier 112. For example, when the VSWR is less than a predetermined value, the controller 114 determines that mismatching is detected.

In this example, the controller 114 computes a power transmission efficiency for each of N tracking frequencies, determines a tracking frequency F_{Best} with the best power transmission efficiency among the N tracking frequencies, and adjusts the reference resonant frequency F_{Ref} to the tracking frequency F_{Best}. In various examples, the N tracking frequencies may be set in advance.

The controller 114 adjusts a frequency of a switching pulse signal. Under the control of the controller 114, the frequency of the switching pulse signal is determined. For example, by controlling the power amplifier 112, the controller 114 may generate a modulation signal to be transmitted to the target device 120. In other words, the communication unit 115 may transmit a variety of data 140 to the target device 120 using in-band communication. The controller 114 detects a reflected wave, and may demodulate a signal received from the target device 120 through an envelope of the detected reflected wave.

The controller 114 may generate a modulation signal for in-band communication, using various methods. For example, the controller 114 may generate the modulation signal by turning on or off a switching pulse signal, by performing delta-sigma modulation, and/or the like. Additionally, the controller 114 may generate a pulse-width modulation (PWM) signal with a predetermined envelope.

The controller 114 determines initial wireless power that is to be transmitted to the target device 120 based on a change in a temperature of the source device 110, a battery state of the target device 120, a change in an amount of power received at the target device 120, and/or a change in a temperature of the target device 120. The source device 110 may further include a temperature measurement sensor (not illustrated) configured to detect a change in temperature. The source device 110 receives information regarding the battery state of the target device 120, the change in the amount of power received at the target device 120, and/or the change in the temperature of the target device 120, through communication with the target device 120. The change in the temperature of the target device 120 may be detected based on data received from the target device 120.

The controller 114 adjusts voltage supplied to the power amplifier 112, using a lookup table. The lookup table is used to store an amount of the voltage to be adjusted based on the change in the temperature of the source device 110, the battery state of the target device 120, the change in the amount of power received at the target device 120, and/or the change in the temperature of the target device 120. For example, when the temperature of the source device 110 and/or the target device 120 rises, the controller 114 lowers the amount of the voltage to be supplied to the power amplifier 112.

The communication unit 115 may perform out-band communication that employs a communication channel. The communication unit 115 may include a communication module, such as one configured to process, for example, ZigBee, Bluetooth, and/or the like. The communication unit 115 may transmit the data 140 to the target device 120 through the out-band communication.

The source resonator 131 transfers an electromagnetic energy 130 to the target resonator 133. For example, the source resonator 131 transfers the communication power and/or charging power to the target device 120, using magnetic coupling with the target resonator 133.

As illustrated in the example of FIG. 1, the target device 120 includes a matching network 121, a rectification unit 122, a DC/DC converter 123, a communication unit 124, and a controller 125. The target resonator 133 receives the electromagnetic energy 130 from the source resonator 131. For example, the target resonator 133 receives the communication power and/or charging power from the source device 110, using the magnetic coupling with the source resonator 131. Additionally, the target resonator 133 may receive the data 140 from the source device 110 using the in-band communication. The target resonator 133 receives the initial wireless power that is determined based on the change in the temperature of the source device 110, the battery state of the target device 120, the change in the amount of power received at the target device 120, and/or the change in the temperature of the target device 120.

The matching network 121 matches an input impedance viewed from the source device 110 to an output impedance viewed from a load. The matching network 121 may be configured with a combination of a capacitor and an inductor.

The rectification unit 122 generates DC voltage by rectifying AC voltage. The AC voltage is received from the target resonator 133. The DC/DC converter 123 adjusts a level of the DC voltage that is output from the rectification unit 122 based on a capacity required by the load. As an example, the DC/DC converter 123 may adjust the level of the DC voltage output from the rectification unit 122 from 3 volts (V) to 10 V.

The power detector 127 detects a voltage of an input terminal 126 of the DC/DC converter 123, and a current and a voltage of an output terminal of the DC/DC converter 123. The detected voltage of the input terminal 126 is used by the controller 125 to compute a transmission efficiency of power received from the source device 110. Additionally, the detected current and the detected voltage of the output terminal is used by the controller 125 to compute an amount of power transferred to the load. The controller 114 of the source device 110 determines an amount of power that needs to be transmitted by the source device 110, based on power required by the load and the power transferred to the load. When power of the output terminal is computed and transferred, using the communication unit 124, to the source device 110, the source device 110 computes an amount of power that needs to be transmitted.

The communication unit 124 may perform in-band communication to transmit or receive data using a resonance frequency. During the in-band communication, the controller 125 demodulates a received signal by detecting a signal between the target resonator 133 and the rectification unit 122, or by detecting an output signal of the rectification unit 122. In other words, the controller 125 demodulates a message received using the in-band communication.

Additionally, the controller 125 adjusts an impedance of the target resonator 133, using the matching network 121, to modulate a signal to be transmitted to the source device 110. For example, the controller 125 may increase the impedance of the target resonator 133 so that a reflected wave may be detected from the controller 114 of the source device 110. Depending on whether the reflected wave is detected, the controller 114 may detect a binary number, for example, “0” or “1.”

The communication unit 124 transmits a response message to the communication unit 115 of the source device 110. For example, the response message may include a type of a corresponding target device, information about a manufacturer of the corresponding target device, a model name of the corresponding target device, a battery type of the corresponding target device, a scheme of charging the corresponding target device, an impedance value of a load of the corresponding target device, information on characteristics of a target resonator of the corresponding target, information on a frequency band used by the corresponding target device, an amount of a power consumed by the corresponding target device, an identifier (ID) of the corresponding target device, information on a version or standard of the corresponding target device, and the like.

The communication unit 124 may perform out-band communication using a communication channel. For example, the communication unit 124 may include a communication module, such as one configured to process ZigBee, Bluetooth, and/or the like. The communication unit 124 may transmit or receive the data 140 to or from the source device 110 using the out-band communication.

The communication unit 124 receives a wake-up request message from the source device 110, and the power detector 127 detects an amount of power received at the target resonator 133. The communication unit 124 transmits, to the source device 110, information on the detected amount of the power. Information on the detected amount may include, for example, an input voltage value and an input current value of the rectification unit 122, an output voltage value and an output current value of the rectification unit 122, an output voltage value and an output current value of the DC/DC converter 123, and/or the like.

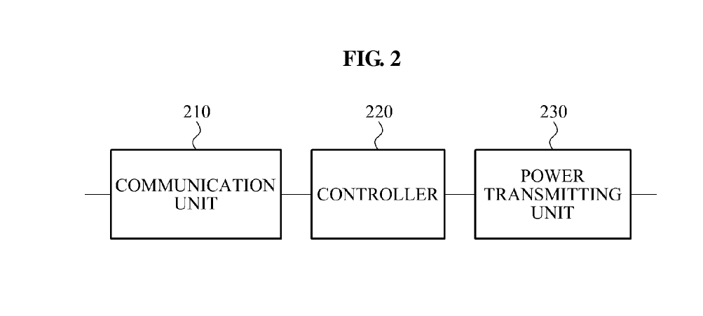

FIG. 2 illustrates an example of a communication apparatus in a wireless power transmission system. The communication apparatus includes a communication unit 210, a controller 220, and a power transmitting unit 230. The communication apparatus may be a source device in the wireless power transmission system.

The controller 220 selects a communication channel from among channels other than a channel used in wireless power transmission. The communication unit 210 transmits a channel occupancy signal, an access standard instruction, and a state information signal, using a communication frequency of the communication channel.

The channel occupancy signal may have a predetermined size, e.g., amplitude. The channel occupancy signal may be a continuous wave (CW) signal that has a predetermined size (e.g., amplitude) and has power higher than a direct sequence spread signal. The channel occupancy signal may be modulated using a predetermined modulation scheme.

The access standard instruction includes information used to check for compatibility between a source device and a target device. The access standard instruction may include a call parameter and a call argument used to identify target devices. For example, when a target device has a same identifying parameter as a call parameter, a response signal is transmitted.

The state information signal indicates an operating mode of a source device. The operating mode may include, for example, a standby mode, an access mode, and/or a charging (transmission) mode.

For example, when power is supplied, a source device performs hardware initialization, reads information from a system configuration block (SCB), and initializes system information. The system information may include, for example, a serial number of the source device, a maximum number of target devices accessible to the source device, a power transmission parameter, a communication channel parameter, and/or the like.

The source device may be operated in a master mode, and a target device may be operated in a slave mode. Accordingly, the source device may function as a subject for each control state, and the target device may provide state information based on a demand by the source device. When abnormality occurs during charging of the target device, the target device automatically performs processing.

The SCB may support at least 8 bytes, and a capacity of the SCB may be increased based on a type of product and an improvement of functions. The SCB may be divided into a system state information region and a unique product serial number region. For example, in an 8-byte structure, each information address may be set from SCB[7] to SCB[0]. An SCB of a source device may be configured as shown in Table 1.

TABLE 1

| | Category | | Description |
|---|---|---|---|
| SCB[7] | Company ID | | Records manufacturer of product in form of numbers |
| | | | or characters, and is used to determine whether source |
| | | | and target are compatible during initial access. For |
| | | | example, SCB[7] may be set to ‘0x01.’ |
| SCB[6] | Classification of | | Defines source as ‘0x01.’ |
| | source and target | | |
| SCB[5] | Product ID | | 1. Indicates resonator efficiency using hexadecimal |
| | | | value. |
| | | | 2. Defines type of product, and defines maximum |
| | | | output, resonator size, and the like. Indicates unique |
| | | | number of product. |
| SCB[4] | Model | Class 1 | Indicates maximum number of targets to be |
| | type | Class 2 | accommodated in source. If three SCBs exist, |
| | | Class 3 | SCB[4] may be ‘0x03.’ |
| | | Class 4 | |

| | | |
|---|---|---|
| SCB[3]~SCB[0] | Serial number | Indicates unique serial number of product in |
| | | manufacturing of product, and sufficient length is |
| | | assigned to prevent unique serial numbers from |
| | | overlapping based on production. If desired, year, |
| | | month, and day may be included. |

Models of a source device may be classified as shown in Table 2 below. A class of the source device may be determined based on a size of the source device, and a minimum power level of power output from the source device. The specific values listed in Table 2 below are only examples, and other values may be used depending on the particular situation.

TABLE 2

| Class | Width (mm) | Length (mm) | Minimum power (W) |
|---|---|---|---|
| Class 1 | 40~60 | 40~60 | 6 |
| Class 2 | 50~90 | 50~90 | 10 |
| Class 3 | 80~180 | 100~250 | 24 |
| Class 4 | 140~200 | 150~300 | 46 |

An SCB of a target device may include a region used to verify compatibility of the target device, a region used to classify products, a region indicating a serial number and information for a unique charging function, and a region associated with compatibility. A serial number of the target device may be used when a source device assigns a control ID. The SCB may be implemented using a memory region of a processor or an external memory. The external memory may include various memory devices, for example, an electrically erasable programmable read-only memory (EEPROM), and/or the like. The SCB of the target device may be configured as shown in Table 3.

TABLE 3

| | Category | | Description |
|---|---|---|---|
| SCB[7] | Company ID | | Indicates ID of manufacturer, for example, may be set |
| | | | to ‘0x01.’ |
| SCB[6] | Classification of | | Defines target as ‘0x00.’ |
| | source and target | | |
| SCB[5] | Product ID | | For example, mobile charger is defined as ‘0x01.’ |
| SCB[4] | Battery | Class 1 | Indicates charging index using hexadecimal value. |
| | type | Class 2 | That is, amount of power required is defined and |
| | | Class 3 | applied. |
| | | Class 4 | |

| | | |
|---|---|---|
| SCB[3]~SCB[0] | Serial number | Unique number of product |

A battery of the target device may be classified as shown in Table 4 below. A class of the target device may be determined based on a size of the target device, and a level of power required by the target device. The specific values listed in Table 4 below are only examples, and other values may be used depending on the particular situation.

TABLE 4

| Category | Width (mm) | Length (mm) | Required power (W) |
|---|---|---|---|
| Class 1 | 20 | 20 | ~1 |
| Class 2 | 40 | 40 | 1~3 |
| Class 3 | 40 | 60 | 3~6 |
| Class 4 | 120 | 120 | 6~12 |

In the standby mode, the source device determines whether a charge command is received. In an example, when a start button is input, the charge command may be received. In another example, when a target device located within a predetermined distance from a source device is detected, the charge command may be automatically received. The source device checks states of all channels that may be used for communication. The source device may measure a level of a received signal strength indicator (RSSI) for each channel, and may determine whether each channel is available.

In an example, when the charge command is received, the source device operates in the access mode. In another example, when the source device is already accessed by the target device, the source device detects a level of a reflected wave. When the level of the reflected wave has a predefined value, the source device determines that another target device exists, and operates in the access mode.

When the target device is detected first, or when the charge command is received, the source device transmits wake-up power to a power transmission channel. The source device may measure the level of the RSSI, or link quality indicator (LQI), in the communication channel. When the level of the RSSI is measured to be equal to or greater than a reference value, the communication channel is determined to be a currently used channel, and the source device may continue to search for a next channel, until a channel with a value less than the reference value is found.

When the channel is found, the source device fixes the found channel, and transmits an access standard instruction based on a reference in the found channel. When target devices respond to the access standard instruction, the source device assigns control IDs to the target devices in an order that the target devices respond to the access standard instruction, to connect to the target devices.

When at least one target device is connected to the source device, the source device transmits wake-up power via a power transmission channel. The source device may transmit an access standard instruction to additionally detected target devices, using a communication channel that is determined already. When the additionally detected target devices respond to the access standard instruction, the source device assigns control IDs to the target devices in an order that the target devices respond to the access standard instruction, to connect to the target devices.

When a control ID is assigned to a target device, the source device operates in the transmission (charging) mode. The source device may receive information regarding power required by the target device from the target device. The information regarding the required power may be stored in an SCB of the target device. The transmission mode may be defined to be set in a period from a point in time in which the source device transmits power, to a point in time in which a battery of the target device is completely charged and a charge control port of the target device is blocked. In the transmission mode, the source device may regularly receive information on a state of the target device, voltage and current of an input terminal of the target device, and voltage and current of an output terminal of the target device, based on rules defined in advance for each product and for each model. The source device may perform a control operation based on the received information.

When a response signal to the access standard instruction is received from the target device, the controller 220 determines a control ID of the target device. The communication unit 210 may continue to transmit the channel occupancy signal until the communication with the target device is terminated. When the channel occupancy signal is continuously transmitted during the communication with the target device, other source devices may detect the channel occupancy signal in the communication channel, and may determine that the communication channel is being used.

The communication unit 210 transmits the control ID to the target device. The communication unit 210 may receive a response signal indicating reception of the control ID from the target device. When the response signal is received, the communication unit 210 transmits a target device information request signal. Subsequently, the communication unit 210 may receive a target device information response signal including information of the target device from the target device. The information of the target device may include, for example, a battery type of the target device, a capacity of the target device, a power initially required by the target device, and/or the like.

The controller 220 determines an initial wireless power that is to be transmitted to the target device, based on the information of the target device, and information on an efficiency of a source resonator included in the source device. The controller 220 may determine the same amount of initial wireless power as an amount of power required by the target device. An efficiency of power transferred by the source device is determined based on a position or direction of the target device. The information on the efficiency of the source resonator may include an efficiency of wireless power transmission based on a position of a target device disposed above a source resonator in a pad-type source device. The controller 220 may determine the initial wireless power based on the power required by the target device, and the efficiency of the source resonator that is determined based on an amount of power received by the target device from the source resonator.

The power transmitting unit 230 wirelessly transmits the initial wireless power, through magnetic coupling between the source resonator of the source device and a target resonator of the target device. When a resonant frequency of the source resonator that resonates is identical to a resonant frequency of the target resonator that resonates, magnetic coupling occurs, and the initial wireless power is transferred.

The communication unit 210 transmits a charging information request signal, and may receive a charging information response signal. The charging information may include information regarding power transferred to a load of the target device.

The controller 220 may compare the charging information with power required by the load of the target device, and may determine power to be transmitted to the target device by a difference between the required power and transferred power. The controller 220 may determine power to be transmitted to the target device, based on the charging information, the power required by the load of the target device, and the information on the efficiency of the source resonator.

When a target device is detected in a wireless power transmission region of the source device, the power transmitting unit 230 transmits wake-up power required for communication of the target device. In response to a charging start command, the power transmitting unit 230 transmits the wake-up power to the wireless power transmission region.

The communication unit 210 transmits a wireless power transmission frame to the target device, through a communication channel. The wireless power transmission frame may be divided into a physical (PHY) layer and a medium access control (MAC) layer. A frame payload of the MAC layer may include a start of text (STX) field, a source (SRC) field, a destination (DST) field, a command (CMD) field, a length (LEN) field, a data field, an end of text (ETX) field, and a checksum (CS) field.

The STX field may indicate a start of a packet. The SRC field may indicate an address for a source device. The DST field may indicate an address for a target device. The CMD field may indicate an instruction transferred from a source device to a target device. The LEN field may indicate a length of the data field or data. The data field may include data associated with an instruction. The EXT field may indicate an end of a packet. The CS field may be used to check an error of a packet.

The CMD field may include at least one of a target reset instruction, an input voltage/current request instruction, an output voltage/current request instruction, a target state request instruction, a target charging control instruction, an access standard instruction, a control ID assignment instruction, a target SCB information request instruction, and a channel change request instruction.

The target reset instruction may be used to reset a target device. For example, when a target device is completely charged, or when abnormality occurs in the target device, a source device may reset the target device. In this example, when voltage and/or current of the target device is maintained at a level below a predetermined level over a predetermined period of time, compared to a power output from the source device, the source device may determine that charging of the target device is completed. The abnormality occurring in the target device may include an increase in a temperature of the target device beyond an optimal temperature.

The input voltage/current request instruction may be used to request a voltage value and/or a current value of an input terminal of a target device, for example, a voltage value and/or a current value inputted to a rectifier or to a DC-DC converter. The output voltage/current request instruction may be used to request a voltage value and/or a current value of an output terminal of a target device, for example, a voltage value and/or a current value output from a DC-DC converter.

The target state request instruction may be applied differently based on a separately defined criterion. The target state request instruction may be used to request a state of a target device, for example, a state in which a temperature of a target device lies beyond an optimal temperature range, a state in which the target device is not charged with power for a predetermined period of time, and/or the like.

The target charging control instruction may be used to turn on or off a port used to charge a load of a target device. The access standard instruction may be associated with a rule in which a control ID is assigned by a source device to a predetermined target device. The access standard instruction may include a reference point, a call argument, and a movement argument. For example, control IDs may be assigned to target devices with the same parameters as a call parameter, in an order that the target devices respond to the access standard instruction.

The control ID assignment instruction may be used to assign a determined control ID to a target device. For example, when a predetermined target device to which a control ID is assigned does not continuously respond M times, a source device may cancel assignment of the control ID to the predetermined target device. In this example, M may be determined based on a situation of the predetermined target device for each product.

The target SCB information request instruction may be used to request information stored in an SCB of a target device. For example, a source device may acquire a requirement to charge the target device, and a requirement to transmit power to the target device, based on the information stored in the SCB of the target device.

The channel change request instruction may be used to request a change in a communication channel that is being used for communication between a source device and a target device. For example, when a currently used channel is in an abnormal communication state, a source device may search for a new channel, and may request a target device to change the currently used channel to the new channel. In this example, the abnormal communication state may include, for example, a state in which there is no response to a request to state information of the target device, a state in which an error occurs in a packet received from the target device, and/or the like.

The controller 220 detects a change in an amount of power output from a power amplifier included in the source device. The controller 220 determines that the load of the target device is changed, by detecting the change in the amount of the output power. This is because, when the load of the target device is changed, the amount of power output from the power amplifier is also changed due to impedance matching. When a change in the load of the target device is detected, the communication unit 210 transmits a charging information request signal, and may receive a charging information response signal. The charging information may include information regarding power that is currently transferred to a load of a current target device.

When charging of the load of the target device is determined to be completed, based on the charging information, the controller 220 generates a target charging control signal. The target charging control signal opens an electrical connection between the target device and the load, to prevent power from being transferred to the load.

The controller 220 determines whether the target device is located in the wireless power transmission region, based on whether a response signal is received in response to the charging information request signal that is transmitted in real time. In other words, the controller 220 determines whether to remove the target device based on whether the charging information response signal is received. Additionally, the communication unit 210 may wait for a predetermined period of time, until the charging information response signal is received.

For example, when the change in the amount of power output from the power amplifier is detected, or when movement of the target device is detected by an external sensor, the controller 220 controls the communication unit 210 to attempt to communicate with the target device. In this example, the controller 220 controls the communication unit 210 to transmit the charging information request signal. The controller 220 determines whether the target device is located in the wireless power transmission region of the source device, based on whether a response signal is received from the target device. When the target device is removed, the amount of power output from the power amplifier is changed.

The communication unit 210 transmits, to the target device, an instruction to request a response, and an instruction not to request a response. The instruction not to request a response may be referred to as a “broadcasting instruction”.

For example, when a broadcasting instruction is received, the target device does not transmit a response signal, and is operated based on information in the broadcasting instruction. The broadcasting instruction may include, for example, a target reset instruction, a channel change request instruction, and/or the like. For example, when a communication channel is changed due to interfering with the communication channel, the source device individually transmits a channel change request instruction to a target device with a registered control ID.

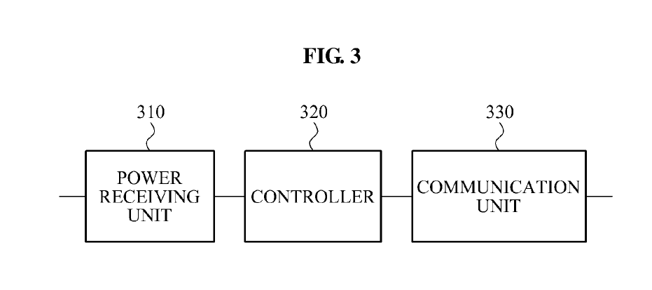

FIG. 3 illustrates another example of a communication apparatus in a wireless power transmission system. The communication apparatus includes a power receiving unit 310, a controller 320, and a communication unit 330. The communication apparatus of may be a target device in the wireless power transmission system.

The communication unit 330 receives, from a source device, a channel occupancy signal, an access standard instruction, and a state information signal, using a communication frequency of a communication channel. The channel occupancy signal may have a predetermined size. The channel occupancy signal may be a CW signal that has a predetermined size and has power higher than a direct sequence spread signal. The channel occupancy signal may be modulated using a predetermined modulation scheme.

The access standard instruction includes information used to check for compatibility between a source device and a target device. The access standard instruction may include a call parameter and a call argument used to identify target devices. For example, when a target device has the same identifying parameter as a call parameter, a response signal is transmitted.

The state information signal indicates an operating mode of a source device. The operating mode may include, for example, a standby mode, an access mode, and/or a charging mode.

The communication unit 330 transmits a response signal corresponding to the access standard instruction. The controller 320 determines the communication channel to be a channel used to communicate with the source device, based on the received channel occupancy signal. For example, when the channel occupancy signal has a value equal to or greater than a reference value, the controller 320 determines the communication channel to be a channel used to communicate with the source device. The controller 320 generates a response signal corresponding to the access standard instruction. For example, when a target device has the same identifying parameter as the call parameter of the access standard instruction, the controller 320 transmits a response signal.

The controller 320 verifies that the source device communicates with another target device in the access mode or the charging mode, based on the state information signal. The state information signal may be received in a format of a wireless power transmission frame. The wireless power transmission frame may include an STX field, an SRC field, a DST field, a CMD field, a LEN field, a data field, an ETX field, and a CS field. The controller 320 verifies the operating mode of the source device, or an address for a target device that the source device desires to communicate, based on the DST field, the CMD field, and the data field.

For example, when the source device is determined to communicate with another target device, the controller 320 waits for communication with another source device. The controller 320 may search for another channel. The target device may attempt to access a source device in another channel.

The communication unit 330 receives a control ID from the source device. The communication unit 330 transmits a response signal indicating reception of the control ID. Additionally, the communication unit 330 receives a target information request signal, and transmits a target information response signal including information of the target device. The information of the target device may include, for example a battery type of the target device, a capacity of the target device, power initially required by the target device, and/or the like.

The power receiving unit 310 wirelessly receives initial wireless power, through magnetic coupling between a source resonator and a target resonator. The initial wireless power is determined by the source device based on the information of the target device. The source resonator and the target resonator are respectively included in the source device and the target device. When a resonant frequency of the source resonator that resonates is identical to a resonant frequency of the target resonator that resonates, magnetic coupling occurs, and the initial wireless power is transferred.

When charging of a load of the target device is determined to be completed, the controller 320 opens electrical connection between the target device and the load, to prevent power from being transferred to the load. The communication unit 330 receives a charging information request signal, and transmits a charging information response signal. The charging information may include information regarding power transferred to the load of the target device.

The controller 320 measures power transferred to the load of the target device. The power transferred to the load of the target device may be computed based on voltage applied to both ends of the load, and current flowing in the load. The controller 320 measures the voltage applied to both ends of the load, and the current flowing in the load.

The communication unit 330 receives a wireless power transmission frame from the source device, through the communication channel. The wireless power transmission frame may be classified into a PHY layer and a MAC layer. A frame payload of the MAC layer may include an STX field, an SRC field, a DST field, a CMD field, a LEN field, a data field, an ETX field, and a CS field.

The STX field may indicate a start of a packet. The SRC field may indicate an address for a source device. The DST field may indicate an address for a target device. The CMD field may indicate an instruction transferred from a source device to a target device. The LEN field may indicate a length of the data field or data. The data field may include data associated with an instruction. The EXT field may indicate an end of a packet. The CS field may be used to check an error of a packet. The CMD field may include at least one of a target reset instruction, an input voltage/current request instruction, an output voltage/current request instruction, a target state request instruction, a target charging control instruction, an access standard instruction, a control ID assignment instruction, a target SCB information request instruction, and a channel change request instruction

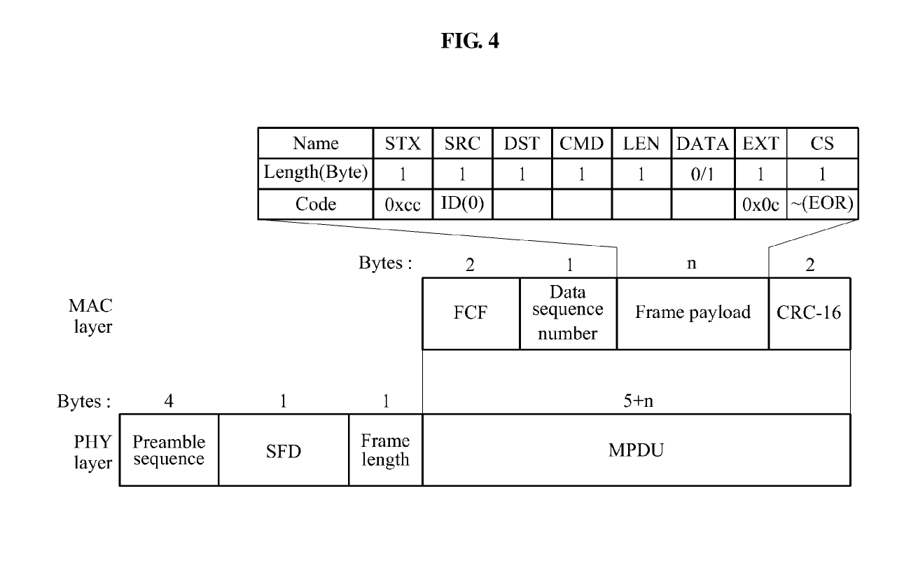

FIG. 4 illustrates an example of a format of a frame transmitted by a communication apparatus in a wireless power transmission system. A source device and a target device may exchange a wireless power transmission frame with each other. The wireless power transmission frame may have the format of FIG. 4. The wireless power transmission frame may be divided into a PHY layer and a MAC layer.

The PHY layer may include a preamble sequence field, a start of frame delimiter (SFD) field, a frame length field, and a MAC protocol data unit (MPDU) field. The preamble sequence field may be used to acquire symbol synchronization or chip synchronization associated with a new frame, and may be used to synchronize a source device and a target device in the PHY layer. The SFD field may indicate a start of a new frame. The frame length field may define a number of all octets included in a MPDU. The MPDU field may indicate MAC information, and may be used to transfer a frame to the MAC layer.

The MAC layer may include a frame control field (FCF), a data sequence number (DSN) field, a frame payload field, and a cycle redundancy check (CRC)-16 field. The FCF may indicate properties of a frame. The properties of the frame may include, for example, a beacon, a notification, a MAC instruction, and the like. The DSN field may indicate a unique sequence ID of a transmitted frame. The frame payload field may indicate information regarding a frame. The CRC-16 field may have a 16-bit CRC code, and may be used to verify an error of a frame using a 16^{th}-order polynomial.

The frame payload field of the MAC layer may include an STX field, an SRC field, a DST field, a CMD field, a LEN field, a data field, an ETX field, and a CS field.

The STX field may indicate a start of a packet. The SRC field may indicate an address for a source device. The DST field may indicate an address for a target device. The CMD field may indicate an instruction transferred from a source device to a target device. The LEN field may indicate a length of the data field or data. The data field may include data associated with an instruction. The EXT field may indicate an end of a packet. The CS field may be used to check an error of a packet. For example, 1 byte may be assigned to each of fields other than the data field. Additionally, a code may be assigned based on information included in each of the fields. For example, ‘0xcc’ may be used as a code to notify a start of a packet.

The CMD field may include at least one of a target reset instruction, an input voltage/current request instruction, an output voltage/current request instruction, a target state request instruction, a target charging control instruction, an access standard instruction, a control ID assignment instruction, a target SCB information request instruction, and a channel change request instruction. The access standard instruction may include information of Table 5. The specific values listed in Table 5 below are only examples, and other values may be used depending on the particular situation.

TABLE 5

| Position | D7 | D6, D5 | D4, D3, D2, D1, D0 |
|---|---|---|---|
| Length | 1 bit | 2 bits | 5 bits |
| Category | M/L | Search bit | Movement argument |
| Initial value | 0 | 2 | 0 |
| Effective value | 0~1 | 0~3 | 0~31 |

In Table 5, the position indicates where a reference point is located in one of 8 bits of 1 byte. For example, D7 may indicate an eighth bit used as a reference point. The reference point may be set to a most significant bit (MSB) or a least significant bit (LSB) among all bits. Since either the MSB or the LSB is used as a reference point, 1 bit may be assigned to D7. For example, ‘0’ may indicate an MSB, and ‘1’ may indicate an LSB.

D6 and D5 may respectively indicate a seventh bit and a sixth bit that are used as call arguments. The call argument may include a number of search bits that need to be searched for based on the reference point, to identify temporary IDs of target devices. For example, two bits may be assigned to each of D6 and D5. In this example, one to four search bits may be used as call arguments.

D0 to D4 may respectively indicate a first bit to a fifth bit that are used as movement arguments. The movement argument may include a number of bits of a search start position that are moved when identifying temporary IDs of target devices using a set call argument fails. Since five bits are assigned to each of D0 to D4, 1 to 32 search bits may be moved.

A source device may transmit a packet, using a frame payload. The packet of the source device may include an STX field, an SRC field, a DST field, a CMD field, a LEN field, a data field, an ETX field, and a CS field, as shown in Table 6.

TABLE 6

| Name | STX | SRC | DST | CMD | LEN | DATA | ETX | CS |
|---|---|---|---|---|---|---|---|---|
| Length | 1 | 1 | 1 | 1 | 1 | n | 1 | 1 |
| Code | 0xCC | ID[0] | | | | | 0x0C | ~(XOR) |

For example, in the STX field, ‘0xCC’ may be used as a code. In the SRC field, an LSB of an ID of a source device may be used as a code. In the access mode, a call parameter may be assigned as a code to the DST field, and in the charging mode, a control ID may be assigned as a code to the DST field. In the CMD field, a code with ‘0’ of an upper nibble may be used. In the LEN field, a length of data may be represented as a code. The data field may indicate a data stream, and a length of the data field may be determined based on a type of instructions. In the ETX field, ‘0x0C’ may be used as a code. The CS field may indicate an error verification scheme, for example, a scheme of performing a complementary eXclusive OR (XOR) operation to bits assigned to the STX field through the ETX field. The specific values listed in Table 6 above are only examples, and other values may be used depending on the particular situation.

A packet of a target device may include an STX field, an SRC field, a DST field, a CMD field, a LEN field, a data field, an ETX field, and a CS field, as shown in Table 7.

TABLE 7

| Name | STX | SRC | DST | CMD | LEN | DATA | ETX | CS |
|---|---|---|---|---|---|---|---|---|
| Length | 1 | 1 | 1 | 1 | 1 | N | 1 | 1 |
| Code | 0xCC | ID[0] | | | | | 0x0C | ~(XOR) |

For example, in the STX field, ‘0xCC’ may be used as a code. In the SRC field, an LSB of an ID of a target device may be used as a code. In the DST field, an ID of a source device may be assigned as a code. In the CMD field, a code with ‘1’ of an upper nibble may be used. In the LEN field, a length of data may be represented as a code. The data field may indicate a data stream, and a length of the data field may be determined based on a type of instructions. In the ETX field, ‘0x0C’ may be used as a code. The CS field may indicate an error verification scheme, for example, a scheme of performing a complementary eXclusive OR (XOR) operation to bits assigned to the STX field through the ETX field. The specific values listed in Table 7 above are only examples, and other values may be used depending on the particular situation.

1. Rules of Transmission and Reception of Packet

A packet transmitted from a source device to a target device may be defined to be a request packet. Additionally, a packet transmitted from the target device to the source device may be defined to be a response packet.

A DST field of a request packet of the source device may include information regarding three examples. In a first example, when a broadcasting instruction is transmitted, a value of ‘0xFF’ may be assigned. In a second example, in the access mode, a call parameter may be assigned. The call parameter may be represented, for example, as ‘0x00,’ ‘0x01,’ ‘0x02,’ and the like. In a third example, in the charging mode, a control ID of the target device may be assigned. The control ID may be represented, for example, as ‘0x01,’ ‘0x02,’ ‘0x0n,’ and the like.

In an example in which the broadcasting instruction is assigned to the DST field of the request packet, the target device may not respond. In another example in which the call parameter or the control ID is assigned to the DST field of the request packet, the target device may transmit a response packet, for example an acknowledge (ACK). Each of a target reset instruction and a channel change request instruction may be set as a broadcasting instruction, or as an individual instruction to which a control ID is assigned. The target device may not use a negative acknowledge (NAK) signal. In another example in which an instruction requiring a response of the target device is transmitted, when the target device does not respond or when a checksum error occurs, the source device may re-transmit the instruction.

2. Examples of Instructions Included in a Request Packet Transmitted from a Source Device to a Target Device

Instructions may be transmitted from a source device to a target device, and may have the structure as shown in Table 8 below. The specific values listed in Table 8 below are only examples, and other values may be used depending on the particular situation.

TABLE 8

| Name | STX | SRC | DST | CMD | LEN | DATA | ETX | CS | |
|---|---|---|---|---|---|---|---|---|---|
| Length (byte) | 1 | 1 | 1 | 1 | 1 | 0/1 | 1 | 1 | Request |
| Code | 0xcc | ID(0) | | | | | 0x0c | ~(XOR) | interval |
| Instruction list | | | | | | | | | |
| Target reset | | | ff, | 0x01 | 0 | none | | | Irregular |
| | | | 1~n | | | | | | |
| Input | | | n | 0x02 | 0 | none | | | 1~60 |
| voltage/current | | | | | | | | | seconds |
| request | | | | | | | | | |
| Output | | | n | 0x03 | 0 | none | | | 1~60 |
| voltage/current | | | | | | | | | seconds |
| request | | | | | | | | | |
| Target state | | | n | 0x04 | 0 | none | | | 1~60 |
| request | | | | | | | | | seconds |
| Target | | | n | 0x05 | 1 | 0x01/00 | | | Irregular |
| charging | | | | | | | | | |
| control | | | | | | | | | |
| Access | | | 0~3 | 0x06 | 1 | | | | Irregular |
| standard | | | | | | | | | |
| Control ID | | | 0~3 | 0x07 | 1 | 0x01~03 | | | One time |
| assignment/ | | | | | | | | | immediately |
| response | | | | | | | | | after access |
| request | | | | | | | | | |
| Target SCB | | | n | 0x08 | 1 | | | | One time |
| request | | | | | | | | | immediately |
| | | | | | | | | | after access |
| Channel | | | ff, | 0x09 | 1 | Ch11~26 | | | Irregular |
| change request | | | 1~3 | | | | | | |

For example, when the target reset instruction is received at a target device, the target device may determine whether to transmit a response packet, based on a type of a DST field of the received instruction, and may be reset. The type of the DST field may include three types corresponding to a case in which a broadcasting instruction is transmitted, a case in which a call parameter is transmitted, and a case in which a control ID is assigned.

When voltage and/or current output from a target device is maintained at a level below a predetermined level for a predetermined period of time, compared to a voltage and/or current input to the target device, or when a temperature of the target device increases beyond an optimal temperature, the source device may determine that an abnormality occurs in the target device. In this case, the source device may transmit the target reset instruction to the target device.

The access standard instruction, the target reset instruction, and the channel change request instruction may be set to a broadcasting instruction, or an individual instruction. In addition, a voltage value and/or current value detected from an input terminal or output terminal of a target device may be converted by a built-in analog-to-digital converter (ADC) or an external ADC, and a transmission length may be determined based on a resolution of a used ADC. In an example of 12 bits, a target device may transmit four bytes in a unit of two bytes. In an example of 8 bits, response data may be ‘ADC_{—}0,’ ‘ADC_{—}1’, ‘ADCO_High’, ‘ADC0_Low,’ ‘ADC1_High’, and ‘ADC1_Low’ may be sequentially set as response data exceeding 8 bits. A voltage value and/or current value may be determined to be detected from either the input terminal or the output terminal, as occasion demands.

The target device may detect the abnormality of the target device, and may transmit, to the source device, a bit set based on a type of the abnormality. For example, the abnormality of the target device may include an abnormality of a temperature of the target device, an abnormality of charging power, and the like.

The target charging control instruction may be used to process a predetermined port of the target device to be high or low. For example, ‘charging on’ may be indicated by ‘0x01,’ and ‘charging of’ may be indicated by ‘0x00.’

The access standard instruction may include an access standard to assign a control ID to a predetermined target device by a source device, and may include, for example, information regarding a call argument, a movement argument, and the like. Control IDs 1 to n may be assigned to target devices, in an order that the target devices access a source device. For example, n may be determined based on a maximum number of target devices accessible to the source device.

When a target device to which a control ID is assigned does not respond to a request packet of a source device M times, the source device may cancel assignment of the control ID. In this example, M may be set for each product, or set based on a situation of a wireless power field.

The source device may transmit a target SCB information request instruction to request information in an SCB of the target device. The source device may verify requirements to charge the target device and to transmit power and data to the target device, based on the response packet.

When a currently used communication channel is in an abnormal state, the source device may search for a new channel, and may request the target device to change the currently used communication channel to the new channel. In this example, the abnormal state of the communication channel may include, for example, a state in which the target device does not respond to a request instruction of the source device, or a state in which an error occurs in a response packet received from the target device.

An ACK may be a response signal of the target device in response to a request from the source device, and may be used by only the target device. The target device may not use a NAK.

When the target device does not respond to a request instruction received from the source device, or when a checksum is not matched, the source device may re-transmit the request instruction K times. In this example, K may be set for each product, or set based on a situation of a wireless power field.

3. Examples of Instructions Included in a Response Packet Transmitted from a Target Device to a Source Device

Instructions transmitted from a target device to a source device may have the same structure as instructions transmitted from the source device to the target device, as shown in Table 9 below. However, there is a difference in an upper nibble of a CMD field. The specific values listed in Table 9 below are only examples, and other values may be used depending on the particular situation.

TABLE 9

| Name | STX | SRC | DST | CMD | LEN | DATA | ETX | CS |
|---|---|---|---|---|---|---|---|---|
| Length | 1 | 1 | 1 | 1 | 1 | 0/1 | 1 | 1 |
| (byte) | | | | | | | | |
| Code | 0xcc | ID(0) | | | | | 0x0c | ~(XOR) |
| Target | | | ff, | 0x11 | 0 | none | | |
| reset | | | 1~n | | | | | |
| Input | | | 1~n | 0x12 | 2/4 | 2/4 | | |
| voltage/ | | | | | | byte | | |
| current | | | | | | | | |
| request | | | | | | | | |
| Output | | | 1~n | 0x13 | 2/4 | 2/4 | | |
| voltage/ | | | | | | byte | | |
| current | | | | | | | | |
| request | | | | | | | | |
| Target | | | 1~n | 0x14 | 1 | 1 | | |
| state | | | | | | byte | | |
| request | | | | | | | | |
| Target | | | 1~n | 0x15 | 0 | none | | |
| charging | | | | | | | | |
| control | | | | | | | | |
| Access | | | 0~n | 0x16 | 0 | none | | |
| standard | | | | | | | | |
| Control ID | | | 0~n | 0x17 | 0 | none | | |
| assign- | | | | | | | | |
| ment/ | | | | | | | | |
| response | | | | | | | | |
| request | | | | | | | | |
| Target | | | 1~n | 0x18 | 8 | 8 byte | | |
| SCB | | | | | | | | |
| request | | | | | | | | |
| Channel | | | ff, | 0x19 | 0 | none | | |
| change | | | 1~n | | | | | |
| request | | | | | | | | |

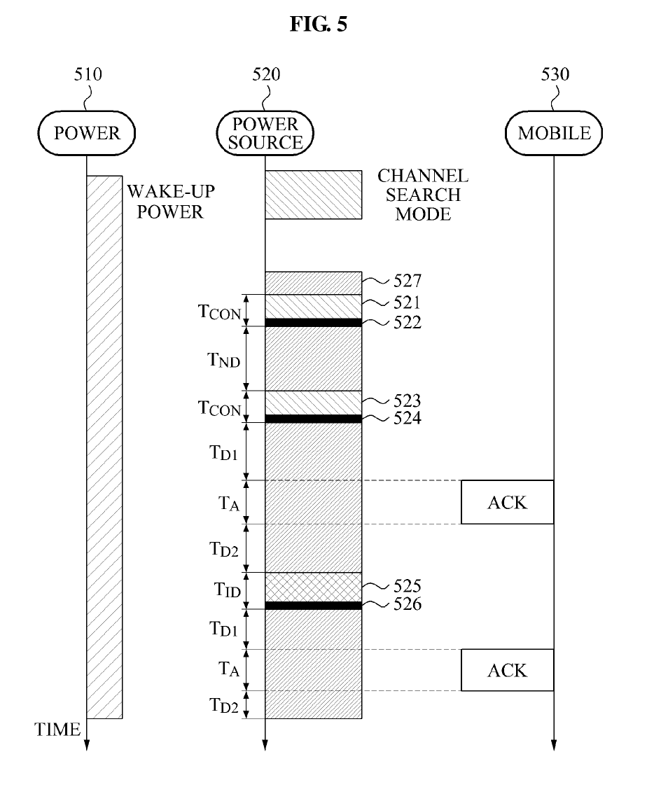

FIG. 5 illustrates an example of an access mode between a source and a single target in a wireless power transmission system. The wireless power transmission system includes a power source 520 and a mobile 530. The mobile 530 may be a target device.

The power source 520 may remain in a standby mode until a start button is actuated. When a charging start command is received, the power source 520 may transmit a wireless power 510, namely, a wake-up power, to a wireless power transmission region. The charging start command may be inputted by actuation of the start button, or inputted immediately when the mobile 530 is detected in the wireless power transmission region.

The power source 520 may communicate with the mobile 530 while transmitting the wireless power 510. In the access mode, the power source 520 may transmit a predetermined amount of the wake-up power. The wake-up power may include a minimum amount of power required by the mobile 530 to perform communication.

In response to the charging start command, the power source 520 may search for a communicable channel in a channel search mode. The power source 520 may measure a level of an interfering signal for each channel, and may determine, as a communication channel, a channel in which a level of an the interfering signal is equal to or less than a reference level.

When the communication channel is determined, the power source 520 may transmit a channel occupancy signal 527, using a communication frequency of the communication channel. The channel occupancy signal 527 may be, for example, a CW signal. The channel occupancy signal 527 may be identified by another source or another target since a bandwidth of the channel occupancy signal 527 is narrower than a typical communication signal, and power of the channel occupancy signal 527 is higher than the typical communication signal. Additionally, another source or another target may determine that the communication channel to receive the channel occupancy signal 527 is being used by the power source 520.

During a time T_{CON}, the power source 520 may transmit an access standard instruction 521 and a state information signal 522. The access standard instruction 521 may include a reference used to assign control IDs to identify the mobile 530 from other targets. For example, a reference point, a call argument, and a movement argument may be used as a reference. When the reference is satisfied (e.g., received), the mobile 530 may transmit an ACK to the power source 520. The state information signal 522 may include information indicating that the power source 520 currently transmits the access standard instruction 521 and is being operated in the access mode. The state information signal 522 may be stored in a portion of a packet.

During a time T_{ND}, the power source 520 may wait until a response signal (e.g., an ACK) corresponding to the access standard instruction 521 is received. The time T_{ND} may include a maximum waiting time set to receive the response signal. During the time T_{ND}, the power source 520 may transmit a CW signal, and may notify neighboring devices that the communication channel is being occupied.

During a time T_{CON}, the power source 520 may transmit an access standard instruction 523 and a state information signal 524. During a time T_{D1}, the power source 520 may wait until a response signal (e.g., an ACK) corresponding to the access standard instruction 523 is received. The time T_{D1} may include a waiting time required to receive the response signal.

During a time T_{A}, the power source 520 may receive the response signal (e.g., the ACK) from the mobile 530. During a time T_{D2}, the power source 520 may determine a control ID based on the received response signal. During the times T_{IN}, T_{A}, and T_{D2}, the power source 520 may transmit a CW signal.

During a time T_{ID}, the power source 520 may transmit a control ID assignment instruction 525 and a state information signal 526. The state information signal 526 may include information indicating that the power source 520 currently transmits the control ID assignment instruction 525 and is being operated in the access mode. For example, when the state information signal 526 is received, neighboring sources and neighboring targets may determine that the power source 520 is being operated in the access mode with the mobile 530, and may search for other channels.

During a time T_{D1}, the power source 520 may wait until a response signal (e.g., an ACK) corresponding to the control ID assignment instruction 525 is received. During a time T_{A}, the power source 520 may receive the response signal (e.g., the ACK) from the mobile 530. During a time T_{D2}, the power source 520 may process an internal operation based on the received response signal. During the times T_{D1}, T_{A}, and T_{D2}, the power source 520 may transmit a CW signal.

When the control ID is assigned to the mobile 530, the power source 520 may be operated in a charging mode. The power source 520 may request information associated with the mobile 530, to transmit power required by the mobile 530. The information associated with the mobile 530 may include, for example, a model name of the mobile 530, charging information regarding a charging state of a battery of the mobile 530, and the like.

The power source 520 may determine initial wireless power to transmit to the mobile 530 based on the charging state information. Additionally, the power source 520 may determine the initial wireless power based on the charging state information and information regarding an efficiency of a source resonator.

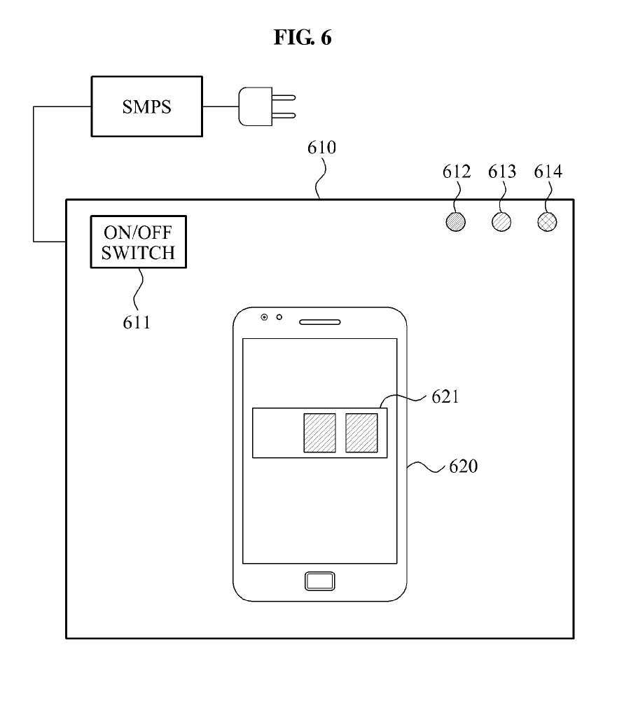

FIG. 6 illustrates an example in which a load of a target is changed in a charging mode in a wireless power transmission system. A source 610 (e.g., a power source or a source device) may be implemented in the form of a pad. The source 610 may receive a power supply from an SMPS via a cable.

An on/off switch 611 may include a charging start button of the source 610 In an example in which the on/off switch 611 is turned on, the source 610 may start a charging process. In another example in which the on/off switch 611 is turned off, the source 610 may terminate the charging process.

The source 610 includes light-emitting diode (LED) indicators 612, 613, and 614. The LED indicator 612 may indicate that the source 610 is being operated in a standby mode, using a color. The LED indicator 613 may indicate that the source 610 is being operated in an access mode, using another color. The LED indicator 614 may indicate that the source 610 is being operated in a charging mode, using still another color. The LED indicator 614 may display different colors to distinguish a state in which the charging process is being performed from a state in which the charging process is completed.

For example, when a target 620 (e.g., a target device) is located in a wireless power transmission region of the source 610, namely, located above the source 610, the charging process may be started, and a power may be transferred from the source 610 to the target 620. A battery charging state indicator 621 of the target 620 may indicate the power used to charge the target 620 by the source 610. When a battery of the target 620 is fully charged, a load of the target 620 may be changed. Due to a change in the load of the target 620, the source 610 may enable the transmitted power to automatically vary through impedance matching.

The LED indicators 612 to 614 may indicate whether initialization of the source 610 is normally performed, whether an abnormality occurs in the source 610, whether the target 620 is being charged by the source 610, and whether a communication error occurs between the source 610 and the target 620. For example, the LED indicators 612 to 614 may display green, red, and yellow, respectively. In this example, when a power is supplied to the source 610, the LED indicators 612 to 614 may sequentially flicker. In another example, when hardware initialization of the source 610 is successfully performed, the LED indicator 612 emitting green may be turned on. In yet another example, when the hardware initialization fails, or when an abnormality occurs while the source 610 is operating, the LED indicator 613 emitting red may flicker. In still another example, when the source 610 is charging the target 620, the LED indicator 613 emitting red may be turned on. In yet another example, when the communication error between the source 610 and the target 620 occurs, the LED indicator 614 emitting yellow may flicker. The above examples may show a relationship between a single target and three LED indicators.

In addition to the LED indicators 612 to 614, a set of other LED indicators may be added based on a number of targets accessible to the source 610. For example, these LED indicators may be disposed on the source 610, and may be turned on or may flicker for each zone. In this example, based on positions of targets, the LED indicators may indicate states, for example, a state in which initialization is completed, a state in which charging is being performed, a state in which a communication error occurs, and the like.

The target 620 may include the set of the other LED indicators, for example, a first LED indicator, a second LED indicator, and a third LED indicator. The first LED indicator may be turned on when hardware initialization is normally performed by supply of the wake-up power to the target 620. The second LED indicator may flicker when hardware initialization is not normally performed, or when an abnormality occurs in an operation of the target 620. The second LED indicator may be turned on when the target 620 is being charged. The third LED indicator may flicker when the communication error occurs between the source 610 and the target 620.

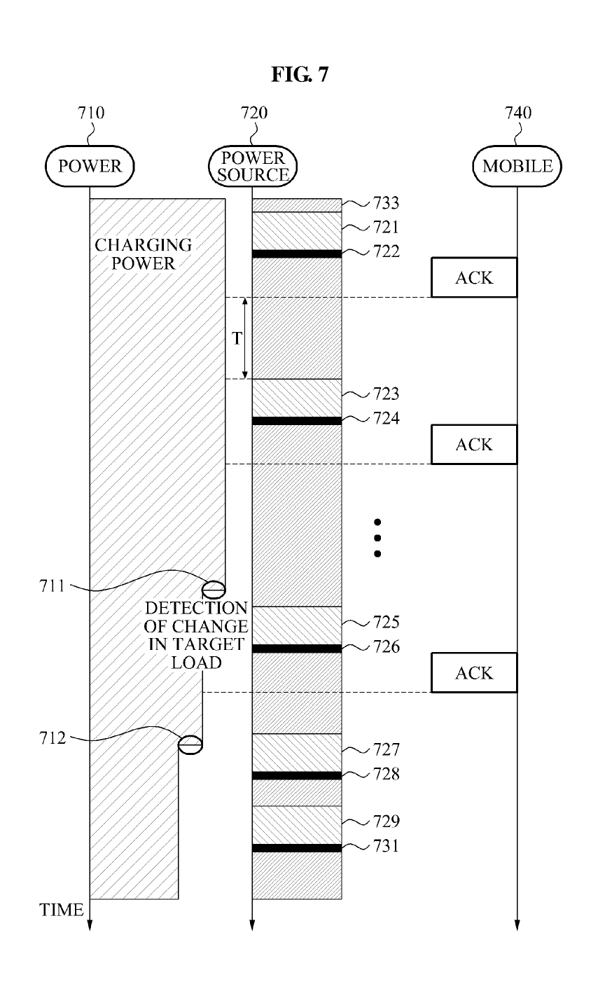

FIG. 7 illustrates an example of an operation of a source that is performed when a load of a target is changed in a charging mode in a wireless power transmission system. The wireless power transmission system includes a power source 720 and a mobile 740. The mobile 740 may be a target device.

The power source 720 may transmit an initial wireless power 710 to the mobile 740. The power 710 transmitted from the power source 720 may be used as a charging power. A block indicated by the charging power may be an amount of the charging power.

The power source 720 may continue to transmit a channel occupancy signal 733 indicating that a communication channel is being occupied. The power source 720 may transmit a charging information request signal 721 and a state information signal 722, using a communication frequency of the communication channel.

The charging information request signal 721 may be used to request charging information regarding a charging state of the mobile 740. For example, the charging information request signal 721 may be transmitted to request a voltage value and/or a current value of an output terminal of the mobile 740.

The state information signal 722 may include information indicating that the power source 720 currently transmits the charging information request signal 721, and is being operated in the charging mode. The state information signal 722 may be stored in a portion of a packet.

The power source 720 may receive an ACK from the mobile 740. The power source 720 may receive, e.g., via the ACK, the charging information from the mobile 740, and may determine whether a load of the mobile 740 is changed based on the charging information.

When a predetermined time T elapses, the power source 720 may transmit a charging information request signal 723 and a state information signal 724. The power source 720 may receive an ACK from the mobile 740.

The power source 720 may transmit a charging information request signal in an interval of time T. When it is determined, based on the charging information, that the load of the mobile 740 is changed, the power source 720 may adjust a power that is to be transmitted to the mobile 740. For example, the power source 720 may adjust an amount of the power to be transmitted based on a charging state of a battery of the mobile 740. The battery may be charged in either a constant current (CC) mode or a constant voltage (CV) mode based on a battery charge level.

Additionally, when the load of the mobile 740 is changed, the power source 720 may perform impedance matching, using a matching network of the power source 720. Accordingly, a power output from a power amplifier of the power source 720 may be changed. In an operation 711, the power source 720 may detect a change in the power output from the power amplifier, and may detect a change in the load of the mobile 740.

When the change in the load of the mobile 740 is detected, the power source 720 may transmit a charging information request signal 725 and a state information signal 726. The power source 720 may receive an ACK from the mobile 740. Additionally, the power source 720 may receive, e.g., via the ACK, the charging information from the mobile 740.

The power source 720 may adjust power that is to be transmitted to the mobile 740 based on a received charging information 727. In an operation 712, the power may be adjusted to an amount corresponding to the change in the load. The power source 720 may transmit a state information signal 728 notifying that the power to be transmitted is being adjusted.

In an operation 729, the power source 720 may transmit the adjusted power to the mobile 740. The power source 720 may transmit a state information signal 731 notifying that the adjusted power is being transmitted.

When charging of the mobile 740 is determined to be completed based on the charging information, the power source 720 may transmit a target charging control instruction to the mobile 740, and may turn off a charging port of the mobile 740. For example, when the charging information request signal 725 is received, and when charging of the battery is determined to be completed, the mobile 740 may automatically turn off the charging port.

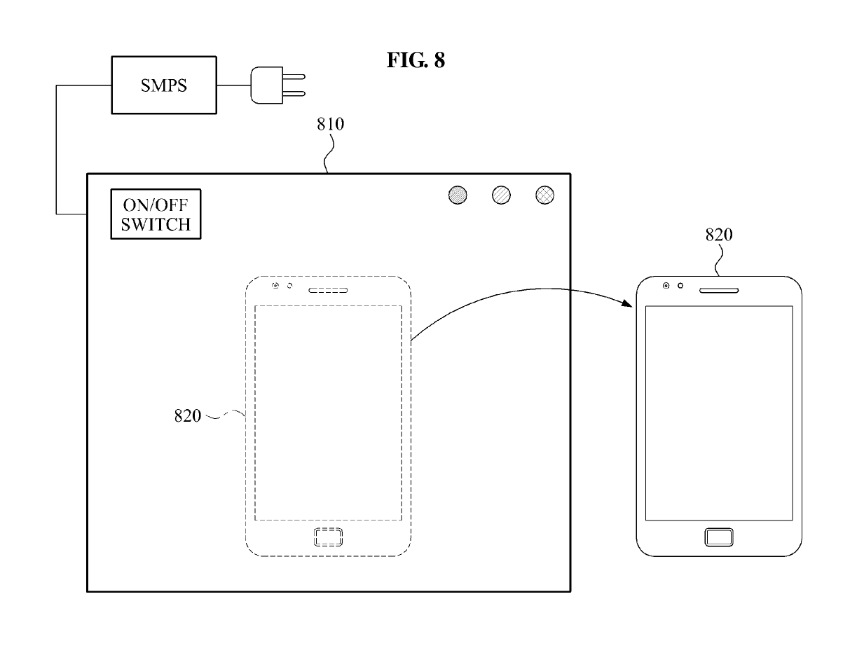

FIG. 8 illustrates an example in which a target is removed during charging in a wireless power transmission system. A source 810 (e.g., a power source or a source device) may be implemented in the form of a pad. The source 810 may receive a power supply from an SMPS via a cable.

For example, when a target 820 (e.g., a target device) is located in a wireless power transmission region of the source 810, namely, located above the source 810, a charging process may be started, and a power may be transferred from the source 810 to the target 820. During the charging process, the target 820 may be removed from the source 810. For example, when the target 820 is spaced apart by a predetermined distance from the source 810, the target 820 may no longer receive the power from the source 810. In other words, when the target 820 is removed from the source 810, the source 810 may detect a removal of the target 820, and may terminate the charging process.

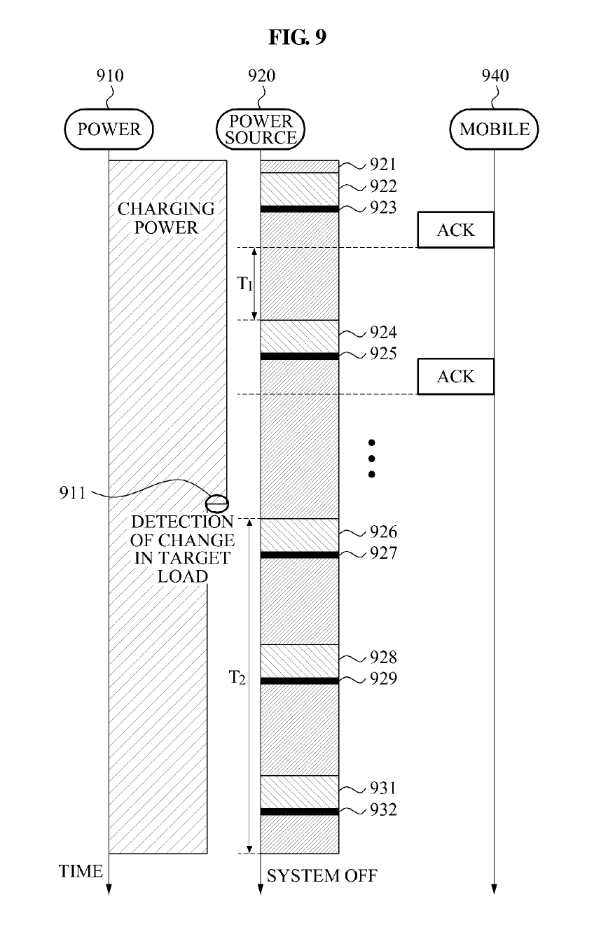

FIG. 9 illustrates an example of an operation of a source that is performed when a target is removed during charging in a wireless power transmission system. The wireless power transmission system includes a power source 920 and a mobile 940. The mobile 940 may be a target device.

The power source 920 may transmit a wireless power 910 to the mobile 940. The power 910 transmitted from the power source 920 may be used as a charging power. A block indicated by the charging power may be an amount of charging power.

The power source 920 may continue to transmit a channel occupancy signal 921 indicating that a communication channel is being occupied. The power source 920 may transmit a charging information request signal 922 and a state information signal 923, using a communication frequency of the communication channel.

The charging information request signal 922 may be used to request charging information regarding a charging state of the mobile 940. For example, the charging information request signal 922 may be transmitted to request a voltage value and/or a current value of an output terminal of the mobile 940.

The state information signal 923 may include information indicating that the power source 920 currently transmits the charging information request signal 922 and is being operated in the charging mode. The state information signal 923 may be stored in a portion of a packet.

The power source 920 may receive an ACK from the mobile 940. The power source 920 may receive, e.g., via the ACK, the charging information from the mobile 940, and may determine whether a load of the mobile 940 is changed based on the charging information.

When a predetermined time T₁ elapses, the power source 920 may transmit a charging information request signal 924 and a state information signal 925. The power source 920 may receive an ACK from the mobile 940.

The power source 920 may transmit a charging information request signal in an interval of time T₁. In an example, when a response signal corresponding to the charging information request signal is not received from the mobile 940 for a predetermined period of time, the power source 920 may determine that the mobile 940 has been removed from the power source 920. In another example, when a control ID request signal is transmitted to the mobile 940, and when a response signal corresponding to the control ID request signal is not received from the mobile 940, the power source 920 may determine that the mobile 940 has been removed from the power source 920.

The power source 920 may monitor power output from a power amplifier of the power source 920. When the output power is changed in an operation 911, the power source 920 may transmit a charging information request signal 926 and a state information signal 927. Subsequently, the power source 920 may wait for a predetermined period of time until a response signal is received.

During a time T₂, the power source 920 may transmit a charging information request signal 928 and a state information signal 929, and may wait until response signals corresponding to the charging information request signal 928 and the state information signal 929 are received. The power source 920 may further transmit a charging information request signal 931 and a state information signal 932, and may wait until response signals corresponding to the charging information request signal 931 and the state information signal 932 are received. When a response signal is not received from the mobile 940 during the time T₂, the power source 920 may determine that the mobile 940 is not located in a wireless power transmission region of the power source 920, e.g., that the mobile 940 has been removed from the power source 920. In another example, the power source 920 may determine that the mobile 940 has been removed from the power source 920, using an external sensor.

When the mobile 940 is determined to have been removed from the power source 920, the power source 920 may terminate the charging process. The power source 920 may further turn off the wireless power transmission system to terminate the charging process.

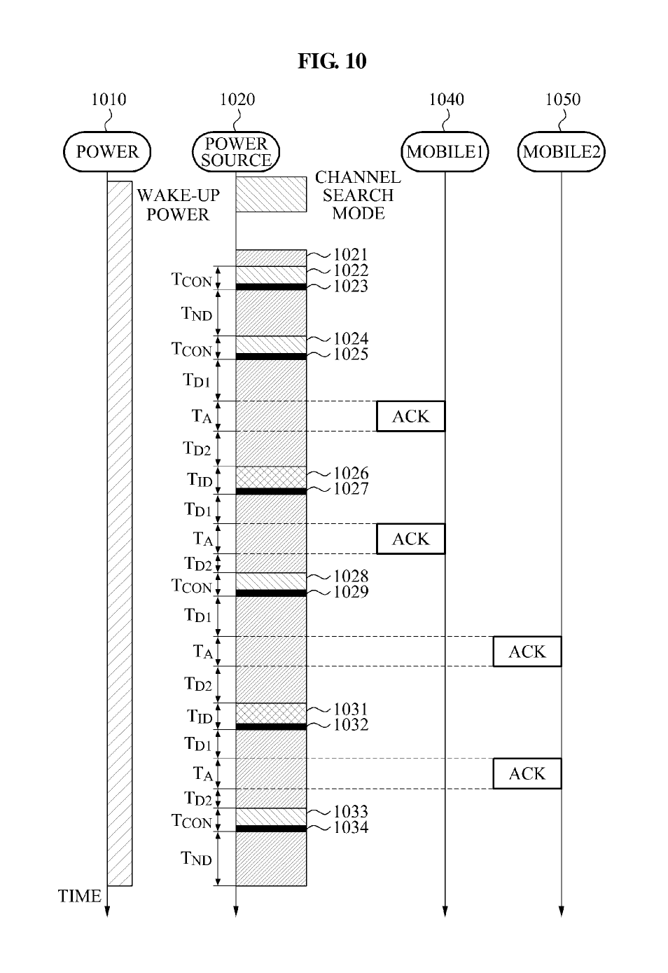

FIG. 10 illustrates an example of an access mode between a source and a plurality of targets in a wireless power transmission system. The wireless power transmission system includes a power source 1020, a first mobile 1040, and a second mobile 1050. The first mobile 1040 and the second mobile 1050 may be a plurality of target devices.

The power source 1020 may remain in a standby mode, until a start button is actuated. When a charging start command is received, the power source 1020 may transmit a wake-up power, namely, a wireless power 1010, to a wireless power transmission region. The charging start command may be inputted by actuation of the start button, or inputted immediately when the first mobile 1040 is detected in the wireless power transmission region.

The power source 1020 may communicate with the first mobile 1040 while transmitting the wireless power 1010. In the access mode, the power source 1020 may transmit a predetermined amount of wake-up power. The wake-up power may include a minimum amount of power required by the first mobile 1040 to perform communication.

In response to the charging start command, the power source 1020 may search for a communicable channel in a channel search mode. The power source 1020 may measure a level of an interfering signal for each channel, and may determine, as a communication channel, a channel in which a level of an interfering signal is equal to or less than a reference level.

When the communication channel is determined, the power source 1020 may transmit a channel occupancy signal 1021, using a communication frequency of the communication channel. The channel occupancy signal 1021 may be, for example, a CW signal. The channel occupancy signal 1021 may be identified by another source or another target since a bandwidth of the channel occupancy signal 1021 is narrower than a typical communication signal, and a power of the channel occupancy signal 1021 is higher than the typical communication signal. Additionally, another source or another target may determine that the communication channel to receive the channel occupancy signal 1021 is being used by the power source 1020.

During a time T_{CON}, the power source 1020 may transmit an access standard instruction 1022 and a state information signal 1023. The access standard instruction 1022 may include a reference used to assign control IDs to identify the first mobile 1040 from the other targets. For example, a reference point, a call argument, and a movement argument may be used as a reference. When the reference is satisfied (e.g., received), the first mobile 1040 may transmit an ACK to the power source 1020. The state information signal 1023 may include information indicating that the power source 1020 currently transmits the access standard instruction 1022 and is being operated in the access mode. The state information signal 1023 may be stored in a portion of a packet.

During a time T_{ND}, the power source 1020 may wait until a response signal (e.g., the ACK) corresponding to the access standard instruction 1022 is received. The time T_{ND} may include a maximum waiting time set to receive the response signal. During the time T_{ND}, the power source 1020 may transmit a CW signal, and may notify neighboring devices that the communication channel is being occupied.

During a time T_{CON}, the power source 1020 may transmit an access standard instruction 1024 and a state information signal 1025. During a time T_{D1}, the power source 1020 may wait until a response signal (e.g., an ACK) corresponding to the access standard instruction 1024 is received. The time T_{D1} may include a waiting time required to receive the response signal. During a time T_{A}, the power source 1020 may receive the response signal (e.g., the ACK) from the first mobile 1040. During a time T_{D2}, the power source 1020 may determine a control ID based on the received response signal. During the times T_{D1}, T_{A}, and T_{D2}, the power source 1020 may transmit a CW signal.

During a time T_{ID}, the power source 1020 may transmit a control ID assignment instruction 1026 and a state information signal 1027. The state information signal 1027 may include information indicating that the power source 1020 currently transmits the control ID assignment instruction 1026 and is being operated in the access mode. For example, when the state information signal 1027 is received, neighboring sources may determine that the power source 1020 is being operated in the access mode with the first mobile 1040, and may search for other channels.

During a time T_{D1}, the power source 1020 may wait until a response signal (e.g., an ACK) corresponding to the control ID assignment instruction 1026 is received. During a time T_{A}, the power source 1020 may receive the response signal (e.g., the ACK) from the first mobile 1040. During a time T_{D2}, the power source 1020 may process an internal operation based on the received response signal. During the times T_{D1}, T_{A}, and T_{D2}, the power source 1020 may transmit a CW signal.

During a time T_{CON}, the power source 1020 may transmit an access standard instruction 1028 and a state information signal 1029. To determine whether a target other than the first mobile 1040 exists, the power source 1020 may transmit the access standard instruction 1028. The access standard instruction 1028 may include a reference used to assign control IDs to identify the second mobile 1050 from the other targets. For example, a reference point, a call argument, and a movement argument may be used as a reference. When the reference is satisfied (e.g., received), the second mobile 1050 may transmit an ACK to the power source 1020.

During a time T_{D1}, the power source 1020 may wait until a response signal (e.g., an ACK) corresponding to the access standard instruction 1028 is received. The time T_{D1} may include a waiting time required to receive the response signal. During a time T_{A}, the power source 1020 may receive the response signal (e.g., the ACK) from the second mobile 1050. During a time T_{D2}, the power source 1020 may determine a control ID based on the received response signal. During the times T_{D1}, T_{A}, and T_{D2}, the power source 1020 may transmit a CW signal.

During a time T_{ID}, the power source 1020 may transmit a control ID assignment instruction 1031 and a state information signal 1032. The state information signal 1032 may include information indicating that the power source 1020 currently transmits the control ID assignment instruction 1031 and is being operated in the access mode. For example, when the state information signal 1032 is received, neighboring sources may determine that the power source 1020 is being operated in the access mode with the second mobile 1050, and accordingly, may search for other channels.

During a time T_{D1}, the power source 1020 may wait until a response signal (e.g., an ACK) corresponding to the control ID assignment instruction 1031 is received. During a time T_{A}, the power source 1020 may receive the response signal (e.g., the ACK) from the second mobile 1050. During a time T_{D2}, the power source 1020 may process an internal operation based on the received response signal. During the times T_{D1}, T_{A}, and T_{D2}, the power source 1020 may transmit a CW signal.

The first mobile 1040 and the second mobile 1050 to which the control IDs are assigned, as described above, may be recognized as targets to be charged by the power source 1020. That is, when the control IDs are assigned to the first mobile 1040 and the second mobile 1050, the power source 1020 may be operated in the charging mode.

Subsequently, during a time T_{CON}, the power source 1020 may transmit an access standard instruction 1033 and a state information signal 1034. For example, when a response signal is not received, even when the access standard instruction is transmitted a predetermined number of times for a predetermined period of time, the power source 1020 may determine that there is no target.

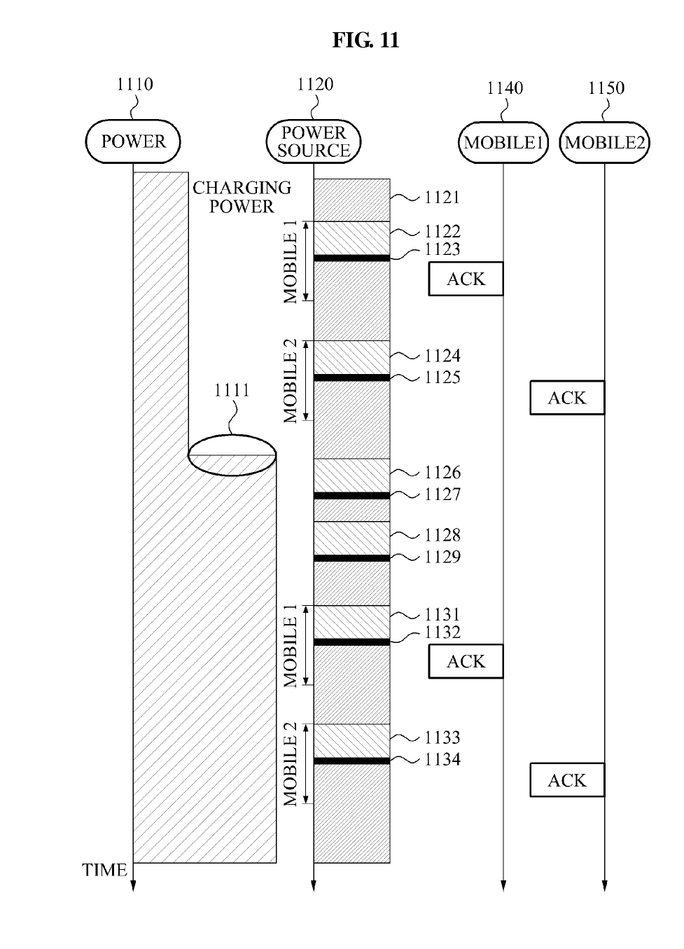

FIG. 11 illustrates an example in which a source verifies a plurality of targets and sets a supplied power in a wireless power transmission system. The wireless power transmission system includes a power source 1120, a first mobile 1140, and a second mobile 1150. The first mobile 1140 and the second mobile 1150 may be a plurality of target devices.

The power source 1120 may transmit an initial wireless power 1110 to the first mobile 1140 and the second mobile 1150. The initial wireless power 1110 may be determined based on information on a battery of the first mobile 1140, and information on a battery of the second mobile 1150.

The power 1110 transmitted from the power source 1120 may be used as a charging power. A block indicated by the charging power may be an amount of the charging power.

The power source 1120 may continue to transmit a channel occupancy signal 1121 indicating that a communication channel is being occupied. The power source 1120 may transmit a charging information request signal 1122 and a state information signal 1123, using a communication frequency of the communication channel.

The charging information request signal 1122 may be used to request charging information regarding a charging state of the first mobile 1140. For example, the charging information request signal 1122 may be transmitted to request a voltage value and/or a current value of an output terminal of the first mobile 1140.

The state information signal 1123 may include information indicating that the power source 1120 currently transmits the charging information request signal 1122 and is being operated in the charging mode. The state information signal 1123 may be stored in a portion of a packet.

The power source 1120 may receive an ACK from the first mobile 1140. The power source 1120 may receive, e.g., via the ACK, the charging information from the first mobile 1140, and may verify a charging state of the battery of the first mobile 1140 based on the charging information.

The power source 1120 may transmit a charging information request signal 1124 and a state information signal 1125, using the communication frequency of the communication channel. The charging information request signal 1124 may be used to request charging information regarding a charging state of the second mobile 1150. For example, the charging information request signal 1124 may be transmitted to request a voltage value and/or a current value of an output terminal of the second mobile 1150.

The power source 1120 may receive an ACK from the second mobile 1150. The power source 1120 may receive the charging information, e.g., via the ACK, from the second mobile 1150, and may verify a charging state of the battery of the second mobile 1150 based on the charging information.

In an operation 1126, the power source 1120 may adjust power to be transmitted to the first mobile 1140 and the second mobile 1150 based on the charging state of the battery of the first mobile 1140, and the charging state of the battery of the second mobile 1150. The power source 1120 may transmit a state information signal 1127 notifying that the power to be transmitted is being adjusted. The power may be adjusted to an amount 1111 of a power that is obtained by adding an amount of a power required by the battery of the first mobile 1140 and an amount of a power required by the battery of the second mobile 1150.

In an operation 1128, the power source 1120 may transmit the adjusted power to the first mobile 1140 and the second mobile 1150. The power source 1120 may transmit a state information signal 1129 notifying that the adjusted power is being transmitted. The power source 1120 may transmit the power until the battery of the first mobile 1140 and the battery of the second mobile 1150 are completely charged.

The power source 1120 may transmit, to the first mobile 1140, a charging information request signal 1131 and a state information signal 1132. The power source 1120 may receive an ACK from the first mobile 1140. The power source 1120 may receive, e.g., via the ACK, the charging information from the first mobile 1140, and may determine whether the battery of the first mobile 1140 is completely charged based on the charging information.

The power source 1120 may transmit, to the second mobile 1150, a charging information request signal 1133 and state information signal 1134. The power source 1120 may receive an ACK from the second mobile 1150. The power source 1120 may receive, e.g., via the ACK, the charging information from the second mobile 1150, and may determine whether the battery of the second mobile 1150 is completely charged based on the charging information.

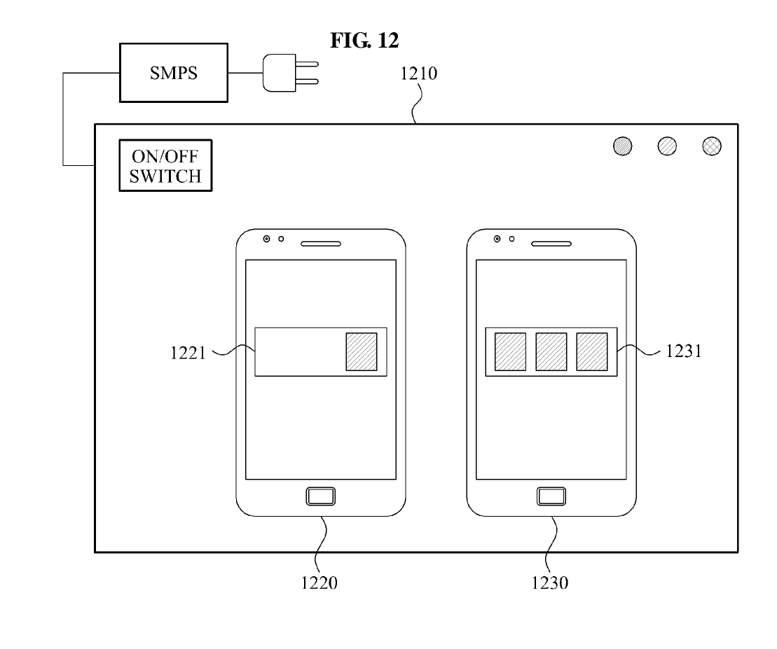

FIG. 12 illustrates an example in which charging of one of a plurality of targets is completed in a wireless power transmission system. A source 1210 may be implemented in the form of a pad. The source 1210 may receive a power supply from an SMPS via a cable.

Targets 1220 and 1230 (e.g., target devices) may receive a wireless power from the source 1210. A battery charging state indicator 1221 of the target 1220 may indicate that charging is not completed, and a battery charging state indicator 1231 of the target 1230 may indicate that charging is completed. Since a battery of the target 1230 is completely charged, the target 1230 may no longer need to be charged. The source 1210 may determine that charging of the target 1230 is completed, and may transmit a signal to control a charging port of the target 1230 to prevent the target 1230 from being charged.

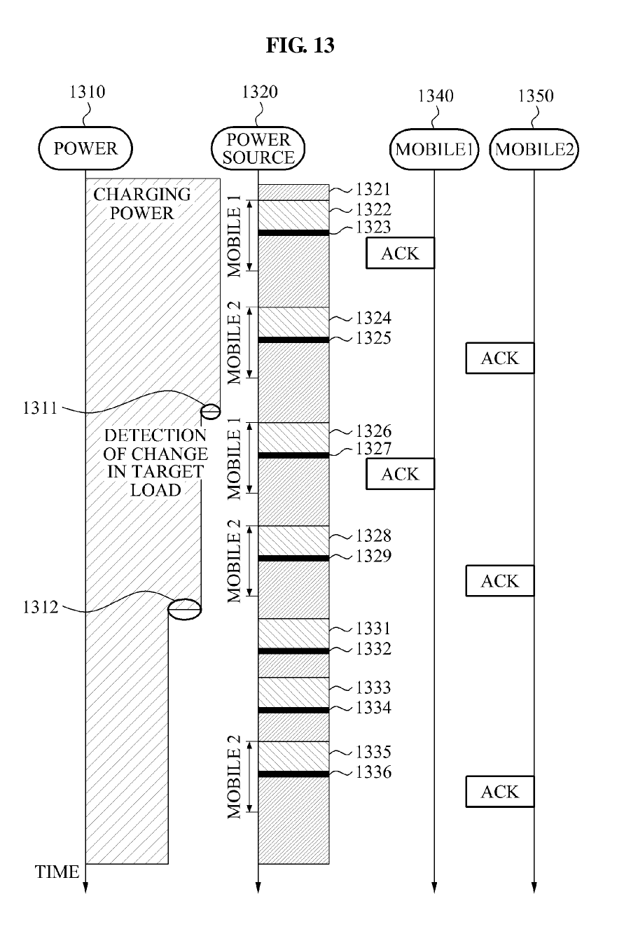

FIG. 13 illustrates an example of operations of a source and a plurality of targets when charging of one of the targets is completed in a wireless power transmission system. The wireless power transmission system includes a power source 1320, a first mobile 1340, and a second mobile 1350. The first mobile 1340 and the second mobile 1350 may be a plurality of target devices.

The power source 1320 may transmit a wireless power 1310 to the first mobile 1340 and the second mobile 1350. The wireless power 1310 may be determined based on a charging state of a battery of the first mobile 1340, and a charging state of a battery of the second mobile 1350. The power 1310 transmitted from the power source 1320 may be represented as a charging power. A block indicated by the charging power may be an amount of charging power.

The power source 1320 may continue to transmit a channel occupancy signal 1321 indicating that a communication channel is being occupied. The power source 1320 may transmit, to the first mobile 1340, a charging information request signal 1322 and a state information signal 1323, using a communication frequency of the communication channel. Since a control ID of the first mobile 1340 is already known, the power source 1320 may easily transmit a signal.

The charging information request signal 1322 may be used to request charging information regarding a charging state of the first mobile 1340. For example, the charging information request signal 1322 may be transmitted to request a voltage value and/or a current value of an output terminal of the first mobile 1340.

The state information signal 1323 may include information indicating that the power source 1320 currently transmits the charging information request signal 1322 and is being operated in the charging mode. The state information signal 1323 may be stored in a portion of a packet.

The power source 1320 may receive an ACK from the first mobile 1340. The power source 1320 may receive, e.g., via the ACK, the charging information from the first mobile 1340, and may determine whether a load of the first mobile 1340 is changed based on the charging information.

The power source 1320 may transmit a charging information request signal 1324 and a state information signal 1325 to the second mobile 1350, using the communication frequency of the communication channel. The power source 1320 may receive an ACK from the second mobile 1350. The power source 1320 may receive, e.g., via the ACK, charging information regarding a charging state of the second mobile 1350 from the second mobile 1350, and may determine whether a load of the second mobile 1350 is changed based on the charging information.

The power source 1320 may transmit a charging information request signal at regular intervals. When it is determined, based on the charging information, that the load of the first mobile 1340 and/or the load of the second mobile 1350 are changed, the power source 1320 may adjust power that is to be transmitted to the first mobile 1340 and the second mobile 1350. For example, the power source 1320 may adjust the power to be transmitted based on the charging state of the battery of the first mobile 1340, and the charging state of the battery of the second mobile 1350. The batteries may be charged in either a CC mode or a CV mode based on battery charge levels.

Additionally, when the load of the first mobile 1340 and/or the load of the second mobile 1350 are changed, impedance matching may be performed via a matching network of the power source 1320. Accordingly, a power output from a power amplifier of the power source 1320 may be changed. In an operation 1311, the power source 1320 may detect a change in the power output from the power amplifier, and may detect changes in the load of the first mobile 1340 and/or the load of the second mobile 1350.

When the changes in the load of the first mobile 1340 and/or the load of the second mobile 1350 are detected, the power source 1320 may transmit, to the first mobile 1340, a charging information request signal 1326 and a state information signal 1327. The power source 1320 may receive an ACK from the first mobile 1340. The power source 1320 may receive, e.g., via the ACK, the charging information from the first mobile 1340. The power source 1320 may determine that the first mobile 1340 is completely charged based on the received charging information.

The power source 1320 may transmit, to the second mobile 1350, a charging information request signal 1328 and a state information signal 1329. The power source 1320 may receive an ACK from the second mobile 1350. The power source 1320 may receive, e.g., via the ACK, the charging information from the second mobile 1350.

In an operation 1331, the power source 1320 may adjust power to be transmitted to the first mobile 1340 and the second mobile 1350 based on the completely charged first mobile 1340 and the currently charged second mobile 1350. The power source 1320 may transmit a state information signal 1332 notifying that the power to be transmitted is being adjusted. The power may be adjusted to an amount of the power 1312 required to completely charge the load of the second mobile 1350.

In an operation 1333, the power source 1320 may transmit the adjusted power 1312 to the second mobile 1350. The power source 1320 may transmit the state information signal 1334 notifying that the adjusted power is being transmitted.

When the first mobile 1340 is determined to be completely charged, based on the charging information, the power source 1320 may transmit a target charging control instruction, and may turn off a charging port of the first mobile 1340. When the charging information request signal 1326 is received, and when the battery is determined to be completely charged, the first mobile 1340 may automatically turn off the charging port.

The power source 1320 may transmit, to the second mobile 1350, a charging information request signal 1335 and a state information signal 1336. The power source 1320 may receive an ACK from the second mobile 1350. The power source 1320 may request the charging information until the second mobile 1350 is completely charged.

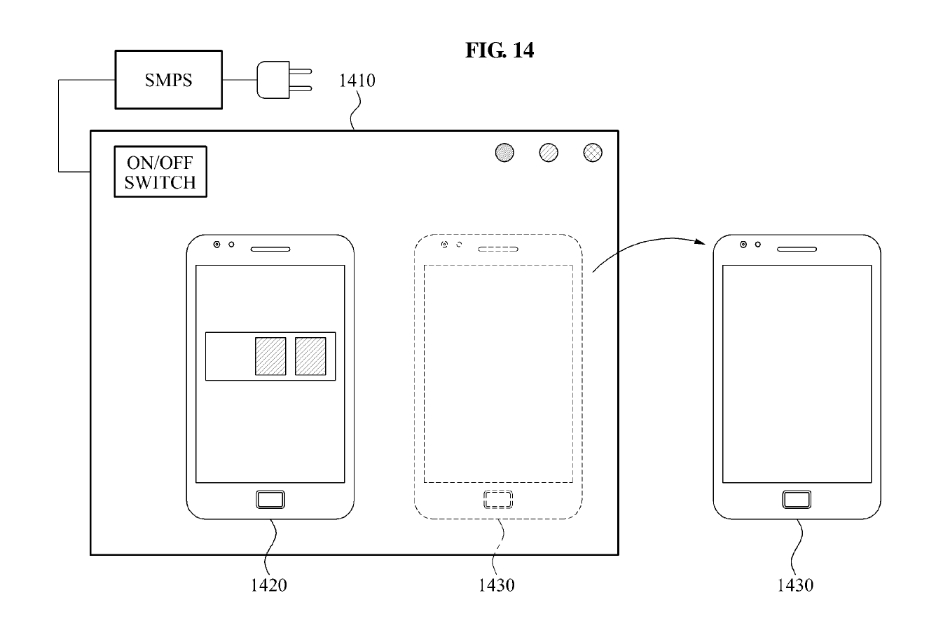

FIG. 14 illustrates an example in which one of a plurality of targets is removed during charging of the targets in a wireless power transmission system. A source 1410 (e.g., a source device) may be implemented in the form of a pad. The source 1410 may receive a power supply from an SMPS via a cable.

Targets 1420 and 1430 (e.g., target devices) may receive a wireless power from the source 1410. The target 1430 disposed on the source 1410 may be moved. For example, when the target 1430 is moved as indicated by an arrow of FIG. 14, the source 1410 may transmit only a power required to charge a battery of the target 1420. Accordingly, an amount of power to be transmitted may need to be adjusted. The source 1410 may detect movement of the target 1430.

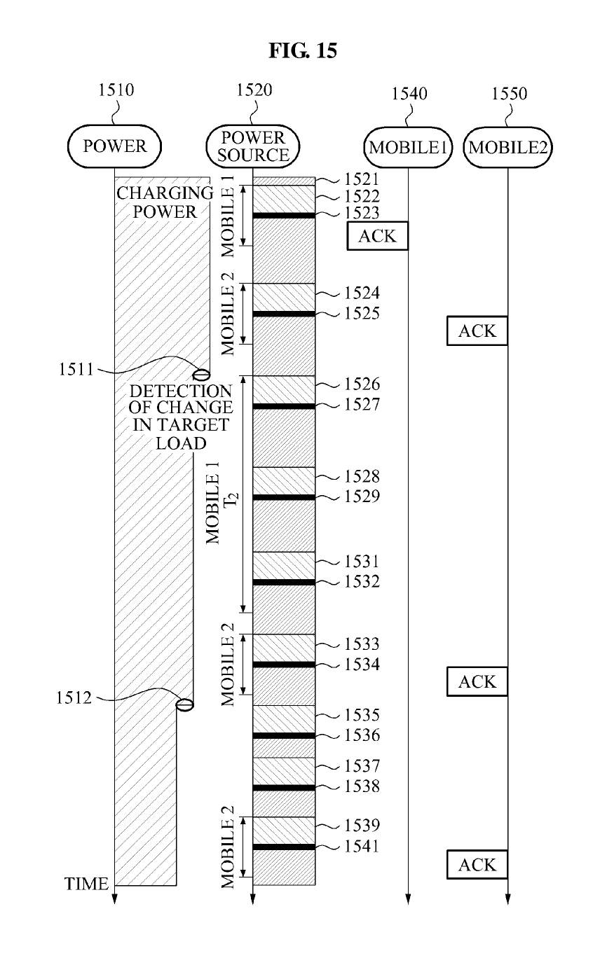

FIG. 15 illustrates an example of operations of a source and a plurality of targets when one of the targets is removed during charging of the targets in a wireless power transmission system. The wireless power transmission system includes a power source 1520, a first mobile 1540, and a second mobile 1550. The first mobile 1540 and the second mobile 1550 may be a plurality of target devices.

The power source 1520 may transmit a wireless power 1510 to the first mobile 1540. The power 1510 transmitted from the power source 1520 may be represented as a charging power. A block indicated by the charging power may be an amount of a charging power.

The power source 1520 may continue to transmit a channel occupancy signal 1521 indicating that a communication channel is being occupied. The power source 1520 may transmit, to the first mobile 1540, a charging information request signal 1522 and a state information signal 1523, using a communication frequency of the communication channel.

The charging information request signal 1522 may be used to request charging information regarding a charging state of the first mobile 1540. For example, the charging information request signal 1522 may be transmitted to request a voltage value and/or a current value of an output terminal of the first mobile 1540.

The state information signal 1523 may include information indicating that the power source 1520 currently transmits the charging information request signal 1522 and is being operated in the charging mode. The state information signal 1523 may be stored in a portion of a packet.

The power source 1520 may receive an ACK from the first mobile 1540. The power source 1520 may receive, e.g., via the ACK, the charging information from the first mobile 1540, and may determine whether a load of the first mobile 1540 is changed based on the charging information.

When a predetermined period of time elapses, the power source 1520 may transmit, to the second mobile 1550, a charging information request signal 1524 and a state information signal 1525. The power source 1520 may receive an ACK from the second mobile 1550. The power source 1520 may receive, e.g., via the ACK, charging information regarding a charging state of the second mobile 1550 from the second mobile 1550, and may determine whether a load of the second mobile 1550 is changed based on the charging information.

The power source 1520 may transmit a charging information request signal at regular intervals. When a response signal corresponding to the charging information request signal is not received from the first mobile 1540 after a predetermined period of time, the power source 1520 may determine that the first mobile 1540 has been removed from a wireless power transmission region of the power source 1520. When a control ID request signal is transmitted to the first mobile 1540, and when a response signal corresponding to the control ID request signal is not received from the first mobile 1540, the power source 1520 may determine that the first mobile 1540 has been removed from the wireless power transmission region.

The power source 1520 may monitor a power output from a power amplifier of the power source 1520. When the output power is changed in an operation 1511, the power source 1520 may transmit, to the first mobile 1540, a charging information request signal 1526 and a state information signal 1527. Subsequently, the power source 1520 may wait for a predetermined period of time until a response signal is received.

During a time T₂, the power source 1520 may transmit a charging information request signal 1528 and a state information signal 1529, and may wait until response signals corresponding to the charging information request signal 1528 and the state information signal 1529 are received. The power source 1520 may further transmit a charging information request signal 1531 and a state information signal 1532, and may wait until response signals corresponding to the charging information request signal 1531 and the state information signal 1532 are received. When a response signal is not received from the first mobile 1540 during the time T₂, the power source 1520 may determine that the first mobile 1540 is no longer located in the wireless power transmission region of the power source 1520, e.g., that the first mobile 1540 has been removed from such a region. In another example, the power source 1520 may determine that the first mobile 1540 has been removed, using an external sensor.

When the first mobile 1540 is determined to have been removed, the power source 1520 may terminate the charging process. The power source 1520 may turn off the wireless power transmission system to terminate the charging process.

When a predetermined period of time elapses, the power source 1520 may transmit, to the second mobile 1550, a charging information request signal 1533 and a state information signal 1534. The power source 1520 may receive an ACK from the second mobile 1550. The power source 1520 may receive, e.g., via the ACK, the charging information from the second mobile 1550, and may determine that the load of the second mobile 1550 is changed based on the charging information.

In an operation 1535, the power source 1520 may adjust power to be transmitted based on the charging information of the currently charged second mobile 1550. The power source 1520 may transmit a state information signal 1536 notifying that the power to be transmitted is being adjusted. The power may be adjusted to a power 1512 required to completely charge the load of the second mobile 1550.

In an operation 1537, the power source 1520 may transmit the adjusted power 1512 to the second mobile 1550. The power source 1520 may transmit a state information signal 1538 notifying that the adjusted power is being transmitted.

The power source 1520 may transmit, to the second mobile 1550, a charging information request signal 1539 and a state information signal 1541. The power source 1520 may receive an ACK from the second mobile 1550. The power source 1520 may request the charging information until the second mobile 1550 is completely charged.

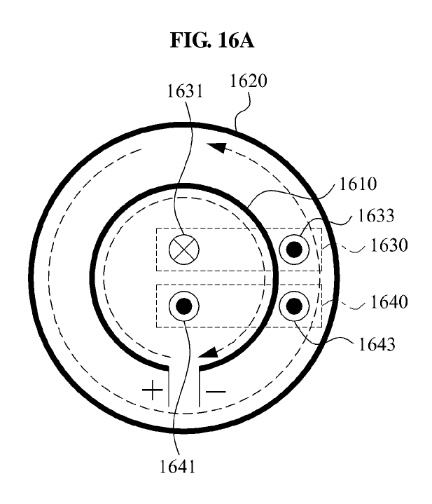

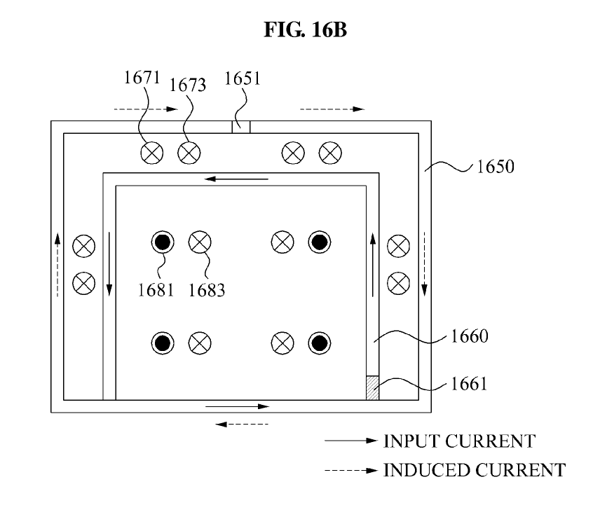

Hereinafter, the term “resonator” in FIGS. 16A through 18B may include, for example, a source resonator and a target resonator.

FIGS. 16A and 16B illustrate examples of a distribution of a magnetic field in a feeder and a resonator. When a resonator receives power supplied through a separate feeder, magnetic fields may be formed in both the feeder and the resonator. In more detail, as input current flows into a feeder 1610, a magnetic field 1630 may be formed. A direction 1631 of the magnetic field 1630 may have a phase that is opposite to a phase of a direction 1633 of the magnetic field 1630 outside the feeder 1610. The magnetic field 1630 may cause induced current to be formed in a resonator 1620. The direction of the induced current may be opposite to a direction of the input current.

Due to the induced current, a magnetic field 1640 may be formed in the resonator 1620. Directions of the magnetic field 1640 in all positions of the resonator 1620 may be the same. Accordingly, a direction 1641 of the magnetic field 1640 may have a same phase as a direction 1643 of the magnetic field 1640.

Consequently, when the magnetic field 1630 formed by the feeder 1610 and the magnetic field 1640 formed by the resonator 1620 are combined, a strength of a total magnetic field may decrease within the feeder 1610, but may increase outside the feeder 1610. In an example in which a power is supplied to the resonator 1620 through the feeder 1610, the strength of the total magnetic field may decrease in a center of the resonator 1620, but may increase outside the resonator 1620. In another example in which a magnetic field is randomly distributed in the resonator 1620, it may be difficult to perform impedance matching since an input impedance may frequently vary.

Additionally, when the strength of the total magnetic field is increased, an efficiency of wireless power transmission may be increased. Conversely, when the strength of the total magnetic field is decreased, the efficiency for wireless power transmission may be reduced. Accordingly, the power transmission efficiency may be reduced on average.

FIG. 16B illustrates an example of a structure of a wireless power transmitter in which a resonator 1650 and a feeder 1660 have a common ground. The resonator 1650 may include a capacitor 1651. The feeder 1660 may receive an input of a radio frequency (RF) signal via a port 1661.

For example, when the RF signal is input to the feeder 1660, an input current may be generated in the feeder 1660. The input current flowing in the feeder 1660 may cause a magnetic field to be formed, and a current may be induced in the resonator 1650 by the magnetic field. Additionally, another magnetic field may be formed due to the induced current flowing in the resonator 1650. In this example, a direction of the input current flowing in the feeder 1660 may have a phase opposite to a phase of a direction of the induced current flowing in the resonator 1650.

Accordingly, in a region between the resonator 1650 and the feeder 1660, a direction 1671 of the magnetic field formed due to the input current may have a same phase as a direction 1673 of the magnetic field formed due to the induced current. Thus, a strength of a total magnetic field may increase in the region between the resonator 1650 and the feeder 1660. Conversely, within the feeder 1660, a direction 1681 of the magnetic field formed due to the input current may have a phase opposite to a phase of a direction 1683 of the magnetic field formed due to the induced current. Thus, a strength of a total magnetic field may decrease within the feeder 1660. Therefore, a strength of a total magnetic field may decrease in a center of the resonator 1650, but may increase outside the resonator 1650.

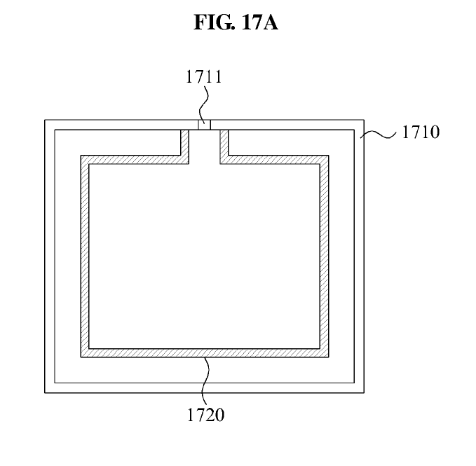

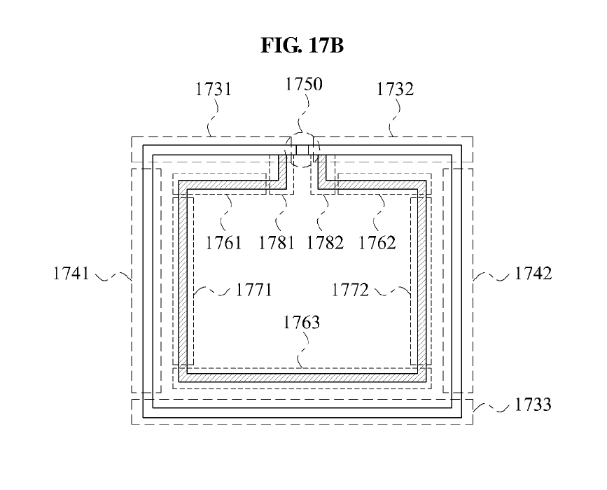

FIG. 17A illustrates an example of a wireless power transmitter. The wireless power transmitter may include a resonator 1710 and a feeding unit 1720. The resonator 1710 may further include a capacitor 1711. The feeding unit 1720 may be electrically connected to both ends of the capacitor 1711.

FIG. 17B illustrates, in more detail, a structure of the wireless power transmitter of FIG. 17A. The resonator 1710 may include a first transmission line, a first conductor 1741, a second conductor 1742, and at least one first capacitor 1750.

The first capacitor 1750 may be inserted in series between a first signal conducting portion 1731 and a second signal conducting portion 1732 in the first transmission line, and an electric field may be confined within the first capacitor 1750. For example, the first transmission line may include at least one conductor in an upper portion of the first transmission line, and may also include at least one conductor in a lower portion of the first transmission line. Current may flow through the at least one conductor disposed in the upper portion of the first transmission line. The at least one conductor disposed in the lower portion of the first transmission line may be electrically grounded. The conductor disposed in the upper portion of the first transmission line may be separated into and referred to as the first signal conducting portion 1731 and the second signal conducting portion 1732. The conductor disposed in the lower portion of the first transmission line may be referred to as a first ground conducting portion 1733.

The resonator 1710 may have a generally two-dimensional (2D) structure. The first signal conducting portion 1731 and the second signal conducting portion 1732 may face the first ground conducting portion 1733. Current may flow through the first signal conducting portion 1731 and the second signal conducting portion 1732.

Additionally, one end of the first signal conducting portion 1731 may be electrically connected (i.e., shorted) to the first conductor 1741, and another end of the first signal conducting portion 1731 may be connected to the first capacitor 1750. One end of the second signal conducting portion 1732 may be shorted to the second conductor 1742, and another end of the second signal conducting portion 1732 may be connected to the first capacitor 1750. Accordingly, the first signal conducting portion 1731, the second signal conducting portion 1732, the first ground conducting portion 1733, and the conductors 1741 and 1742 may be connected to each other, so that the resonator 1710 may have an electrically closed-loop structure. The term “loop structure” may include, for example, a polygonal structure such as a circular structure, a rectangular structure, and the like. The term “having a loop structure” may be used to indicate that the circuit is electrically-closed.

The first capacitor 1750 may be inserted into an intermediate portion of the first transmission line. For example, the first capacitor 1750 may be inserted into a space between the first signal conducting portion 1731 and the second signal conducting portion 1732. The first capacitor 1750 may be configured as a lumped element, a distributed element, and the like. For example, a capacitor configured as a distributed element may include zigzagged conductor lines and a dielectric material that has a high permittivity positioned between the zigzagged conductor lines.

When the first capacitor 1750 is inserted into the first transmission line, the resonator 1710 may have a characteristic of a metamaterial. The metamaterial indicates a material having a predetermined electrical property that has not been discovered in nature, and thus, having an artificially designed structure. An electromagnetic characteristic of the materials existing in nature may have a unique magnetic permeability or a unique permittivity. Most materials may have a positive magnetic permeability or a positive permittivity.

In the case of most materials, a right hand rule may be applied to an electric field, a magnetic field, and a pointing vector, and thus, the corresponding materials may be referred to as right handed materials (RHMs). However, the metamaterial that has a magnetic permeability or a permittivity absent in nature may be classified into an epsilon negative (ENG) material, a mu negative (MNG) material, a double negative (DNG) material, a negative refractive index (NRI) material, a left-handed (LH) material, and the like, based on a sign of the corresponding permittivity or magnetic permeability.

When a capacitance of the first capacitor 1750 inserted as the lumped element is appropriately determined, the resonator 1710 may have the characteristic of the metamaterial. Because the resonator 1710 may have a negative magnetic permeability by appropriately adjusting the capacitance of the first capacitor 1750, the resonator 1710 may also be referred to as an MNG resonator. Various criteria may be applied to determine the capacitance of the first capacitor 1750. For example, the various criteria may include a criterion that enables the resonator 1710 to have the characteristic of the metamaterial, a criterion that enables the resonator 1710 to have a negative magnetic permeability in a target frequency, a criterion that enables the resonator 1710 to have a zeroth-order resonance characteristic in the target frequency, and the like. Based on at least one criterion among the aforementioned criteria, the capacitance of the first capacitor 1750 may be determined.

The resonator 1710, also referred to as the MNG resonator 1710, may have a zeroth-order resonance characteristic of having, as a resonance frequency, a frequency when a propagation constant is “0”. Because the resonator 1710 may have a zeroth-order resonance characteristic, the resonance frequency may be independent with respect to a physical size of the MNG resonator 1710. By appropriately designing or configuring the first capacitor 1750, the MNG resonator 1710 may sufficiently change the resonance frequency without changing the physical size of the MNG resonator 1710.

In a near field, for example, the electric field may be concentrated on the first capacitor 1750 inserted into the first transmission line. Accordingly, due to the first capacitor 1750, the magnetic field may become dominant in the near field. The MNG resonator 1710 may have a relatively high Q-argument using the first capacitor 1750 of the lumped element, and thus, it may be possible to enhance an efficiency of power transmission. For example, the Q-argument may indicate a level of an ohmic loss or a ratio of a reactance with respect to a resistance in the wireless power transmission. The efficiency of the wireless power transmission may increase according to an increase in the Q-argument.

Although not illustrated in FIG. 17B, a magnetic core may be further provided to pass through the MNG resonator 1710. The magnetic core may perform a function of increasing a power transmission distance.

Referring to FIG. 17B, the feeding unit 1720 may include a second transmission line, a third conductor 1771, a fourth conductor 1772, a fifth conductor 1781, and a sixth conductor 1782.

The second transmission line may include a third signal conducting portion 1761 and a fourth signal conducting portion 1762 in an upper portion of the second transmission line. In addition, the second transmission line may include a second ground conducting portion 1763 in a lower portion of the second transmission line. The third signal conducting portion 1761 and the fourth signal conducting portion 1762 may face the second ground conducting portion 1763. Current may flow through the third signal conducting portion 1761 and the fourth signal conducting portion 1762.

Additionally, one end of the third signal conducting portion 1761 may be shorted to the third conductor 1771, and another end of the third signal conducting portion 1761 may be connected to the fifth conductor 1781. One end of the fourth signal conducting portion 1762 may be shorted to the fourth conductor 1772, and another end of the fourth signal conducting portion 1762 may be connected to the sixth conductor 1782. The fifth conductor 1781 may be connected to the first signal conducting portion 1731, and the sixth conductor 1782 may be connected to the second signal conducting portion 1732. The fifth conductor 1781 and the sixth conductor 1782 may be connected in parallel to both ends of the first capacitor 1750. In this example, the fifth conductor 1781 and the sixth conductor 1782 may be used as input ports to receive an RF signal as an input.

Accordingly, the third signal conducting portion 1761, the fourth signal conducting portion 1762, the second ground conducting portion 1763, the third conductor 1771, the fourth conductor 1772, the fifth conductor 1781, the sixth conductor 1782, and the resonator 1710 may be connected to each other, so that the resonator 1710 and the feeding unit 1720 may have an electrically closed-loop structure. When an RF signal is received via the fifth conductor 1781 or the sixth conductor 1782, an input current may flow in the feeding unit 1720 and the resonator 1710, a magnetic field may be formed due to the input current, and a current may be induced to the resonator 1710 by the formed magnetic field. A direction of the input current flowing in the feeding unit 1720 may be a same as a direction of the induced current flowing in the resonator 1710. Thus, a strength of a total magnetic field may increase in a center of the resonator 1710, but may decrease outside the resonator 1710.

An input impedance may be determined based on an area of a region between the resonator 1710 and the feeding unit 1720 and accordingly, a separate matching network used to match the input impedance to an output impedance of a power amplifier may not be required. For example, even when the matching network is used, the input impedance may be determined by adjusting a size of the feeding unit 1720, and thus, a structure of the matching network may be simplified. The simplified structure of the matching network may minimize a matching loss of the matching network.

The second transmission line, the third conductor 1771, the fourth conductor 1772, the fifth conductor 1781, and the sixth conductor 1782 may form a same structure as the resonator 1710. In an example in which the resonator 1710 has a loop, structure, the feeding unit 1720 may also have a loop structure. In another example in which the resonator 1710 has a circular structure, the feeding unit 1720 may also have a circular structure.

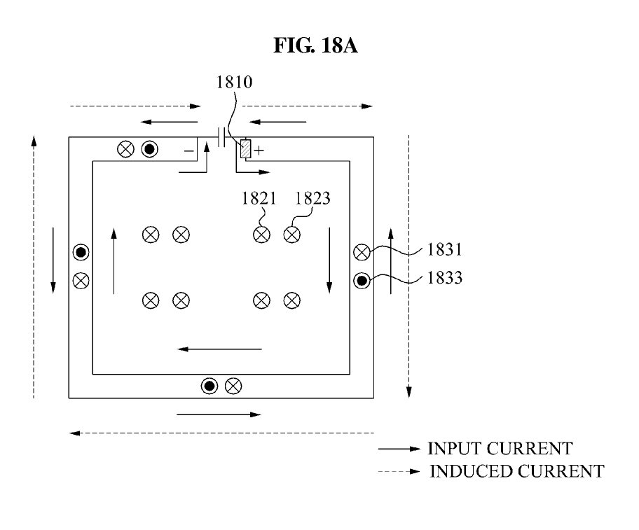

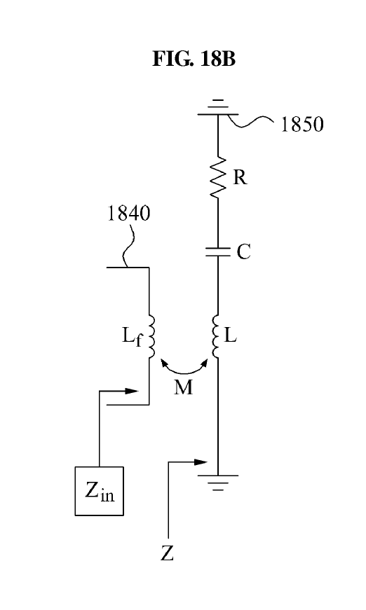

FIG. 18A illustrates an example of a distribution of a magnetic field within a resonator based on feeding of a feeding unit. In other words, FIG. 18A illustrates the resonator 1710 and the feeding unit 1720 of FIG. 17A, in more detail.

A feeding operation may include supplying power to a source resonator in wireless power transmission, or include supplying AC power to a rectification unit in a wireless power transmission. FIG. 18A illustrates a direction of an input current flowing in the feeding unit 1720, and a direction of an induced current induced in the source resonator 1710. Additionally, FIG. 18A illustrates a direction of a magnetic field formed due to the input current of the feeding unit 1720, and a direction of a magnetic field formed due to the induced current of the source resonator 1710.

In more detail, referring to FIGS. 17A, 17B and 18A, the fifth conductor 1781 or the sixth conductor 1782 of the feeding unit 1720 may be used as an input port 1810. The input port 1810 may receive an RF signal as an input. The RF signal may be output from a power amplifier. The power amplifier may increase or decrease an amplitude of the RF signal based on a demand of a target device. The RF signal received by the input port 1810 may be displayed in the form of an input current flowing in the feeding unit 1720. The input current may flow in a clockwise direction in the feeding unit 1720, along a transmission line of the feeding unit 1720.

The fifth conductor 1781 of the feeding unit 1720 may be electrically connected to the resonator 1710. More specifically, the fifth conductor 1781 may be connected to a first signal conducting portion of the resonator 1710. Accordingly, the input current may flow in the resonator 1710, as well as, in the feeding unit 1720. The input current may flow in a counterclockwise direction in the resonator 1710. The input current flowing in the resonator 1710 may cause a magnetic field to be formed, so that an induced current may be generated in the resonator 1710 due to the magnetic field. The induced current may flow in a clockwise direction in the resonator 1710. For example, the induced current may transfer energy to a capacitor (e.g., the capacitor 1711) of the resonator 1710, and a magnetic field may be formed due to the induced current. In this example, the input current flowing in the feeding unit 1720 and the resonator 1710 is indicated by a solid line of FIG. 18A, and the induced current flowing in the resonator 1710 is indicated by a dotted line of FIG. 18A.

A direction of a magnetic field formed due to a current may be determined based on the right hand rule. Within the feeding unit 1720, a direction 1821 of a magnetic field formed due to the input current flowing in the feeding unit 1720 may be identical to a direction 1823 of a magnetic field formed due to the induced current flowing in the resonator 1710. Accordingly, a strength of a total magnetic field may increase within the feeding unit 1720.

Additionally, in a region between the feeding unit 1720 and the resonator 1710, a direction 1833 of a magnetic field formed due to the input current flowing in the feeding unit 1720 may have a phase opposite to a phase of a direction 1831 of a magnetic field formed due to the induced current flowing in the source resonator 1710. Accordingly, a strength of a total magnetic field may decrease in the region between the feeding unit 1720 and the resonator 1710.

The feeding unit 1720 may be electrically connected to both ends of the capacitor of the resonator 1710, and accordingly, the induced current of the resonator 1710 may flow in a same direction as the input current of the feeding unit 1720. Since the induced current of the resonator 1710 flows in the same direction as the input current of the feeding unit 1720, a strength of a total magnetic field may increase within the feeding unit 1720, and may decrease outside the feeding unit 1720. As a result, the strength of the total magnetic field may increase in a center of the resonator 1710 with the loop structure, and may decrease outside the resonator 1710, due to the feeding unit 1720. Thus, the strength of the total magnetic field may be equalized within the resonator 1710.

A power transmission efficiency of transferring a power from the resonator 1710 to a target resonator may be in proportion to the strength of the total magnetic field formed in the resonator 1710. In other words, when the strength of the total magnetic field increases in the center of the resonator 1710, the power transmission efficiency may also increase.

FIG. 18B illustrates one equivalent circuit of a feeding unit 1840, and one equivalent circuit of a resonator 1850. The feeding unit 1840 and the resonator 1850 may be expressed as equivalent circuits. An example of an input impedance Zᵢₙ viewed in a direction from the feeding unit 1840 to the resonator 1850 may be computed, as given in Equation 1.

$${Z}_{in} = \frac{{( ω M )}^{2}}{Z} \qquad [ Equation 1 ]$$

In Equation 1, M denotes a mutual inductance between the feeding unit 1840 and the resonator 1850, a) denotes a resonance frequency between the feeding unit 1840 and the resonator 1850, and Z denotes an impedance viewed in a direction from the resonator 1850 to a target device. The input impedance Zᵢₙ may be in proportion to the mutual inductance M. Accordingly, the input impedance Zᵢₙ may be controlled by adjusting the mutual inductance M. The mutual inductance M may be adjusted based on an area of a region between the feeding unit 1840 and the resonator 1850. The area of the region between the feeding unit 1840 and the resonator 1850 may be adjusted based on a size of the feeding unit 1840. Accordingly, the input impedance Zᵢₙ may be determined based on the size of the feeding unit 1840, and thus, a separate matching network may not be required to perform impedance matching with an output impedance of a power amplifier.

In a target resonator and a feeding unit that are included in a wireless power receiver, a magnetic field may be distributed as illustrated in FIG. 18A. For example, the target resonator may receive a wireless power from a source resonator through magnetic coupling. Due to the received wireless power, an induced current may be generated in the target resonator. A magnetic field formed due to the induced current in the target resonator may cause another induced current to be generated in the feeding unit. In this example, when the target resonator is connected to the feeding unit as illustrated in FIG. 18A, the induced current generated in the target resonator may flow in a same direction as the induced current generated in the feeding unit. Thus, a strength of a total magnetic field may increase within the feeding unit, but may decrease in a region between the feeding unit and the target resonator.

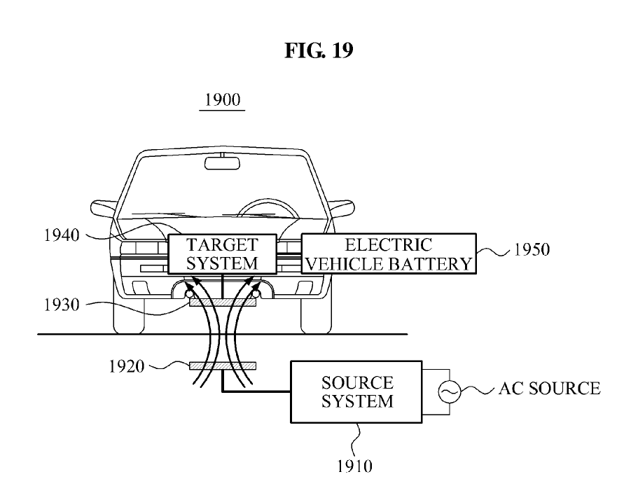

FIG. 19 illustrates an example of an electric vehicle charging system. An electric vehicle charging system 1900 may include a source system 1910, a source resonator 1920, a target resonator 1930, a target system 1940, and an electric vehicle battery 1950.

The electric vehicle charging system 1900 may have a similar structure to the wireless power transmission system of FIG. 1. The source system 1910 and the source resonator 1920 may function as a source device. Additionally, the target resonator 1930 and the target system 1940 may function as a target device. The source system 1910 may include a variable SMPS, a power amplifier, a matching network, a controller, and a communication unit, similarly to the source device 110 of FIG. 1. The target system 1940 may include a matching network, a rectification unit, a DC/DC converter, a communication unit, and a controller, similarly to the target device 120 of FIG. 1.

The electric vehicle battery 1950 may be charged by the target system 1940. The electric vehicle charging system 1900 may use a resonant frequency in a band of a few kilohertz (KHz) to tens of MHz.

The source system 1910 may generate power, based on a type of a charging vehicle, a capacity of a battery, and a charging state of a battery, and may supply the generated power to the target system 1940. The source system 1910 may control the source resonator 1920 and the target resonator 1930 to be aligned. For example, when the source resonator 1920 and the target resonator 1930 are not aligned, the controller of the source system 1910 may transmit a message to the target system 1940, and may control alignment between the source resonator 1920 and the target resonator 1930.

For example, when the target resonator 1930 is not located in a position enabling maximum magnetic resonance, the source resonator 1920 and the target resonator 1930 may not be aligned. When a vehicle does not stop accurately, the source system 1910 may induce a position of the vehicle to be adjusted, and may control the source resonator 1920 and the target resonator 1930 to be aligned.

The source system 1910 and the target system 1940 may transmit or receive an ID of a vehicle, or may exchange various messages, through communication. The descriptions of FIGS. 2 through 18B may be applied to the electric vehicle charging system 1900. However, the electric vehicle charging system 1900 may use a resonant frequency in a band of a few KHz to tens of MHz, and may transmit power that is equal to or higher than tens of watts to charge the electric vehicle battery 1950.

As described above, according to various examples, there is provided a wireless power transmission system in which a target device may receive a state information signal associated with a communication channel from a source device, during searching for the communication channel. The target device may further determine a state of the communication channel based on the received state information signal, and may determine whether the communication channel is available. Additionally, according to various examples, in the wireless power transmission system, a source device may continue to receive information from a load of the target device, and may efficiently compute an amount of power that needs to be transmitted.

Furthermore, according to various examples, in the wireless power transmission system, the source device may transmit an access standard instruction. When a response signal is received from the target device satisfying an access standard, the source device may assign a control ID to the target device. Thus, it is possible to prevent the source device and the target device from colliding with each other when the target device accesses the source device.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums. The computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein.

As a non-exhaustive illustration only, a terminal or device described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A terminal (which is sometimes referred to as a computer terminal) may be an electronic or electromechanical hardware device that is used for entering data into, and displaying data from, a host computer or a host computing system. In various examples, an operative function of a terminal may be confined to display and input of data; though a terminal with a significant local programmable data processing capability may be referred to as a “smart terminal” or fat client. A terminal that depends on the host computer for its processing power may be referred to as a thin client. A personal computer can run software that emulates the function of a terminal, sometimes allowing concurrent use of local programs and access to a distant terminal host system.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A source device of a wireless power transmission system, the source device comprising:
a communication unit configured to transmit an access standard instruction on a communication channel having a frequency that is not used for wireless power transmission; and
a controller configured to
assign, to a target device, a control identifier (ID) if a response signal responding to the access standard instruction is received from the target device, and
determine an initial wireless power to be transmitted to the target device based on a change in a temperature of the source device, or a battery state of the target device, or a change in an amount of a power received by the target device, or a change in a temperature of the target device, or any combination thereof.

2. The source device of claim 1, wherein the communication unit is further configured to:
transmit, to the target device, the control ID;
receive, from the target device, a response signal indicating that the target device has received the control ID;
transmit, to the target device, a target information request signal requesting information about the target device; and
receive, from the target device, a target information response signal comprising the information about the target device.

3. The source device of claim 1, further comprising:
a source resonator; and
a power transmitting unit configured to wirelessly transmit, to the target device, the initial wireless power through a magnetic coupling between the source resonator and a target resonator of the target device.

4. The source device of claim 1, further comprising:
a power amplifier configured to receive a power supply voltage; and
a lookup table configured to store changes in the temperature of the target device and corresponding adjustments of the power supply voltage,
wherein the controller is further configured to
detect the change in the temperature of the target device based on data from the target device, and
adjust the power supply voltage based on the change in the temperature of the target device and the lookup table.

5. The source device of claim 4, wherein:
the controller is further configured to detect a change in an output power of the power amplifier, and determine that a load of the target device has changed based on the change in the output power of the power amplifier; and
the communication unit is further configured to transmit, to the target device, a charging information request signal requesting information regarding a power being transferred to the load of the target device, and receive, from the target device, a charging information response signal comprising the information regarding the power being transferred to the load of the target device.

6. The source device of claim 1, wherein the controller is further configured to:
select the communication channel from a plurality of communication channels having respective frequencies that are not used for wireless power transmission; and
transmit a channel occupancy signal indicating that the communication channel is being used, and a state information signal indicating an operating mode of the source device.

7. A target device of a wireless power transmission system, the target device comprising:
a communication unit configured to
receive, from a source device, a channel occupancy signal and an access standard instruction, using a frequency of a communication channel, and
transmit, to the source device, a response signal responding to the access standard instruction;
a controller configured to
determine the communication channel as a channel used to communicate with the source device based on the channel occupancy signal, and
generate the response signal responding to the access standard instruction; and
a target resonator configured to receive, from the source device, an initial wireless power determined based on a change in a temperature of the source device, or a battery state of the target device, or a change in an amount of a power received by the target device, or a change in a temperature of the target device, or any combination thereof.

8. The target device of claim 7, wherein the communication unit is further configured to receive, from the source device, a state information signal indicating an operating mode of the source device.

9. The target device of claim 8, wherein, when the state information signal indicates a communication between the source device and another target device in an access mode or a charging mode, the controller is further configured to wait for communication with another source device.

10. The target device of claim 7, wherein the communication unit is further configured to:
receive, from the source device, a control identifier (ID);
transmit, to the source device, a response signal indicating that the target device has received the control ID;
receive, from the source device, a target information request signal requesting information about the target device; and
transmit, to the source device, a target information response signal comprising the information about the target device.

11. The target device of claim 7, wherein, when charging of a load of the target device is determined to be completed, the controller is further configured to open an electrical connection between the target device and the load to prevent a power from being transferred to the load.

12. The target device of claim 7, wherein, when the controller is awaken, the controller is further configured to:
initialize hardware of the target device; and
acquire a serial number of the target device, a battery type of the target device, a power transmission parameter, and a parameter of the communication channel, from a system configuration block (SCB).

13. A method of a wireless power transmission system, the method comprising:
transmitting an access standard instruction on a communication channel having a frequency that is not used for wireless power transmission;
assigning, to a target device, a control identifier (ID) if a response signal responding to the access standard instruction is received from the target device; and
determining an initial wireless power to be transmitted to the target device based on a change in a temperature of a source device, or a battery state of the target device, or a change in an amount of a power received by the target device, or a change in a temperature of the target device, or any combination thereof.

14. The method of claim 13, further comprising:
transmitting, to the target device, the control ID;
receiving, from the target device, a response signal indicating that the target device has received the control ID;
transmitting, to the target device, a target information request signal requesting information about the target device; and
receiving, from the target device, a target information response signal comprising the information about the target device.

15. The method of claim 13, further comprising wirelessly transmitting, to the target device, the initial wireless power through a magnetic coupling between a source resonator of the source device and a target resonator of the target device.

16. The method of claim 13, further comprising:
detecting a change in output power of a power amplifier of the source device; and
determining that a load of the target device has changed based on the output power of the power amplifier.

17. The method of claim 13, further comprising:
selecting the communication channel from a plurality of communication channels having respective frequencies that are not used for wireless power transmission; and
transmitting a channel occupancy signal indicating that the communication channel is being used, and a state information signal indicating an operating mode of the source device.

18. An method of a wireless power transmission system, the method comprising:
receiving, from a source device, a channel occupancy signal and an access standard instruction, using a frequency of a communication channel;
transmitting, to the source device, a response signal responding to the access standard instruction;
determining the communication channel as a channel used to communicate with the source device based on the channel occupancy signal;
generating the response signal responding to the access standard instruction; and
receiving, from the source device, an initial wireless power determined based on a change in a temperature of the source device, or a battery state of a target device, or a change in an amount of a power received by the target device, or a change in a temperature of the target device, or any combination thereof.

19. The method of claim 18, further comprising receiving, from the source device, a state information signal indicating an operating mode of the source device.

20. The method of claim 18, wherein the response signal comprises the battery state of the target device, or the change in the amount of the power received by the target device, or the change in the temperature of the target device, or any combination thereof.
